(19) United States
(12) Patent Application Publication
(10) Pub. No.: US 2003/0097309 A1
(43) Pub. Date: May 22, 2003

(54) Systems and methods for providing lighting solutions over a computer network

(76) Inventors: Zachary Shane Gibler, Lawrenceville, GA (US); Timothy A. Hogan, Conyers, GA (US); Patrick M. Quinn, Lilburn, GA (US); Charles J. Darnell, Decatur, GA (US); Doug Stang, Decatur, GA (US)

Correspondence Address: JOHN S. PRATT, ESQ, KILPATRICK STOCKTON, LLP, 1100 PEACHTREE STREET, SUITE 2800, ATLANTA, GA, 30309, US

(21) Appl. No.: 10/005,099

(22) Filed: Dec. 5, 2001

Related U.S. Application Data
(60) Provisional application No. 60/251,368, filed on Dec. 5, 2000.

(51) Int. Cl. G06F 17/60

(52) U.S. Cl. 705/26

(57) ABSTRACT

Methods and systems provide specific, high-value solutions to customers with lighting system needs. The systems provide numerous functionalities to aid users in determining what products are appropriate for their lighting projects. One functionality includes a tool that moves users from design concept to order placement in an easy-to-follow format. A design center allows users to review product catalogs and mix and match products to select the appropriate lighting solution. Additionally, marketing and technical information is provided, and users may manage the full life-cycle of their lighting projects.

This application claims priority to U.S. Provisional Application No. 60/251,368 filed Dec. 5, 2000, entitled “Systems and Methods for Providing Lighting Solutions over the Internet,” which document is incorporated herein by reference.

### FIELD OF THE INVENTION

The present invention relates to systems and processes for marketing, designing, ordering, and selling lighting products, in addition to managing installation and maintenance projects in the commercial and industrial (C&I) lighting industry, over the Internet or other computer network.

### BACKGROUND OF THE INVENTION

Deregulation has forced utilities to expand beyond core markets to insure revenue streams and to meet profit objectives. One of the primary energy-related services that utilities are expanding into is providing solutions for the C&I lighting market. This effort is the outgrowth of tariff-based lighting programs that have been a core offering from utilities for many decades. Historically, utilities have offered basic lighting services on a non-metered basis including street lighting, security lighting, and general area lighting. The limited products offered included cobraheads, floods, shoe boxes, NEMA (National Electrical Manufacturers Association) heads, and ornamentals. Typically, application of the products was based on location of distribution systems rather than on lighting criteria. Utilities used service planners to promote their lighting offerings and utility distribution crews to install and maintain the equipment. Customers paid a monthly fee for the equipment that included material, installation, and maintenance under regulatory guidelines that limited product offerings. In the regulated industry, product was stored in utility facilities until required for a new installation or maintenance of existing systems.

As utilities move to compete in the entire C&I lighting marketplace by offering customer-driven solutions, the existing utility infrastructure is not fully capable of meeting market requirements. These capability gaps can be consolidated into three general areas: initial product promotion/selection; product delivery and construction; and program maintenance.

Product selection, site design, and order placement typically are very time consuming. Although customers would like more choices in products and services solutions, utility personnel and customers are often unaware of the various offerings available from the utility and the performance characteristics of the products. Additionally, utilities do not have an organization that is capable of fully promoting a new lighting offering or the in-house design expertise for lighting applications. Lack of product knowledge drives the utility and its customers to make lighting decisions based first on cost of the individual units.

Product delivery gaps exist for several reasons. Tariff constraints limit the utilities' ability to offer new products in the regulated market, and non-regulated offerings require NEC (National Electrical Code) compliance, which is not a utility standard. Additionally, utilities are not always willing or capable of offering leasing options to their customers, and utilities rarely have established relationships with C&I lighting product suppliers. Competitive pressures have forced utilities to limit the warehousing of products while, at the same time, utilities do not have good materials management programs that reduce costs. Finally, existing utility crews are inexperienced with C&I products and are typically more expensive than commercial contractors.

Some of the major competitive companies in utility lighting, such as Cooper Lighting and General Electric (GE), have active general information websites that generally provide product catalogs. Such product catalogs contain pictures of various lighting products in addition to more detailed information about the products, such as size, wattage, voltage, and other specification data.

A primary limitation of current practices relates to providing customers and utility personnel information on available products and application tools. Additionally, utility procurement procedures are cumbersome and, typically, time consuming, and utilities do not have an effective tool to manage new projects and continuing maintenance. Finally, internal resources used to install, to maintain, to finance, and to administer current lighting programs may not most efficiently provide solutions in new markets.

Existing utility lighting programs do not fully meet customer needs nor maximize profits. New deregulated market opportunities mean that the disparity between existing programs and utility business goals will increase. Current supplier relationships are driven by utility procurement procedures and do not focus on utility customer requirements. Most importantly, utilities do not have an efficient method of providing their customers lighting solutions in new lighting markets.

### SUMMARY OF THE INVENTION

This invention is directed to systems and methods of providing lighting products and services, marketing lighting products through partnered utility-lighting websites on the Internet, and significantly increasing customer penetration and effectiveness. Further, by aligning with trade allies, a utility can provide a complete solution that increases operational efficiencies, expands market opportunities, and provides a self-service solution to their customers, thus creating the first complete package capability to operate from “start to finish” with utility customers.

According to the invention, the system includes a customer support function that overcomes current utility limitations by augmenting or replacing traditional sales/supply processes including product selection, site design, product delivery, and financial solutions. The system provides a structured guide that allows customers to select products and lighting solutions without interfacing with a service planner. Additionally, information on lighting practice, regulations, pricing, and typical applications for simple projects is also available. The system according to the invention may further include a design center where customers can process basic layouts and have more complex designs completed via electronic means.

The system also provides an information repository to expedite business and track performance allowing the utility to more efficiently provide lighting services to its customers. The system allows customers to order lighting systems over the Internet and enhance materials management capabilities. Furthermore, according to the invention, the system may support online project management and coordination of installation and materials and simplify maintenance procedures. All of the functions discussed above reduce time to market and transactional costs for the utility and its customers. Additional opportunities include capturing customer information as a resource for other business opportunities through data mining.

An embodiment of a system according to the invention includes customization of the website for each registered utility user. For users, access to information is provided based on the log-in password used. The website may be customized to be utility-specific in its design and product content. Based on URL (uniform resource locator), the site displays the unique products, design tools, catalog information, photographs, pricing, and educational tools for each utility. Florida Power & Light, for example, would have a different URL than Detroit Edison. These sites may be hosted from one location, but they give each utility a personalized site for it and its customers. Each view displays only the information, products, and pricing specific to the individual utility. For random browsers discovering the site, products are displayed without pricing, sales support data, or technical documents.

Some advantages of systems and methods according to the invention include: providing a mechanism for utilities to more efficiently promote lighting solutions to their customers; streamlining processes and eliminating inefficiencies in current business practices at utilities; and providing a system that unites various suppliers into a single solution and procurement center that simplifies transactions for the utility and its customers. These and other objects, features, and advantages of the present invention may be more clearly understood and appreciated from a review of the following detailed description of the disclosed embodiments and by reference to the appended drawings.

### BRIEF DESCRIPTION OF THE DRAWINGS

FIGS. 1-5 are exemplary screen shots showing a main interface to the methods and systems of the present invention, including user log in and new user registration.

FIGS. 6-15 are exemplary screen shots illustrating a tool or road map feature according to a system of the invention and exemplary steps thereof that allow users to design their own lighting systems for a lighting project.

FIGS. 16-18 are exemplary screen shots showing submission of application and order requests.

FIGS. 19-22 are exemplary screen shots depicting lighting design for an exemplary environment of a baseball field.

FIGS. 23-26 are exemplary screen shots illustrating a roadway lighting tool according to a system of the present invention.

FIGS. 27-30 are exemplary screen shots showing a lumen method tool according to a system of the present invention.

FIGS. 31-33 are exemplary screen shots illustrating a design studio feature according to a system of the invention.

FIGS. 34-42 are exemplary screen shots illustrating a product catalog and exemplary lighting options about which users may obtain further and more detailed information.

FIGS. 43-50 are exemplary screen shots illustrating a design center or design palette of a system according to the invention, including various embodiments of the design center with various lighting options and various background scenes.

FIGS. 51-55 are exemplary screen shots illustrating case studies or job portfolios of lighting projects which users may view.

FIGS. 56-64 are exemplary screen shots showing calculators available to users, including a lease/buy calculator that allows users to compare the cost of buying lighting equipment versus the cost of leasing lighting equipment.

FIGS. 65-76 are exemplary screen shots illustrating how users may view and manage lighting projects.

FIGS. 77-79 are exemplary screen shots showing various information users can access regarding advantages of lighting projects for particular types of developments.

FIGS. 80-87 are exemplary screen shots illustrating where users may obtain information about lighting, including photometric data, product brochures, glossaries, and other educational and general information.

### DETAILED DESCRIPTION OF THE INVENTION

I. Overview

This invention is directed to systems and methods of providing lighting products and services through the Internet or any other applicable computer network. Systems and methods according to the invention may increase operational efficiencies, expand market opportunities, and provide self-service solutions to lighting customers, thus creating a complete package capability to operate from “start to finish” with utility customers.

A tool or road map feature according to a system and method of the present invention allows users to design their lighting systems and request proposals for designs of lighting projects. An embodiment according to a system of the invention includes several steps in which users are prompted for information about their lighting project and are then presented with one or more lighting options or lighting components of a lighting system. Alternate embodiments may include providing users with the ability to place lighting orders and design lighting projects in a less structured manner. Roadway lighting and lumen method tools are also available for assistance with roadway and interior lighting projects, respectively.

Systems and methods according to the invention may include a product catalog, a design center, and sample case studies. An exemplary product catalog allows users to view detailed information about the size, specifications, and other characteristics of various lighting products or components. A design center or design palette according to a system of the invention allows users to view a variety of lighting components within a variety of background scenes, including background scenes which may be uploaded by users from their own files. The case studies or job portfolios allow users to view actual lighting projects where the potentially-selected lighting components have been used. This provides users with real world views of their potential selections.

Calculators may also be available to users, including a lease/buy calculator that allows users to compare the cost of buying lighting equipment versus the cost of leasing lighting equipment. A project or job management center provides a portal through which users can check the status of ongoing projects and utilities can more efficiently manage the estimation, procurement, installation, and maintenance of lighting projects.

Systems and methods according to the invention may also provide informative content to users. For example, users can access information regarding advantages of lighting projects for particular types of developments including residential, commercial, industrial, indoor, or outdoor lighting projects. Additionally, a library or educational center allows users to obtain information about lighting, including photometric data, product brochures, glossaries, and other educational and general information.

While systems and methods of the invention are described generally with reference to an exemplary embodiment, other embodiments are discussed herein to illustrate alternatives and additional embodiments not discussed herein will be apparent to those skilled in the art. While light poles and lighting fixtures for outdoor lighting are shown prominently in the exemplary screen shots, it should be understood that the invention is not limited to the examples shown and that additional lighting equipment, products, or components or may be featured according to systems and methods of the invention. Other lighting options for indoor and outdoor lighting for commercial, institutional, industrial, infrastructure, and residential applications, including architectural and landscape lighting products (including underwater), may be featured using systems and methods according to the invention. Examples include, but are not limited to, indoor residential, restaurant, warehouse, office or professional building, retail store, school, hospital, parking garage, sports arena, emergency system, lighting control system, and numerous other types of indoor and outdoor commercial, industrial, and institutional lighting.

While the utility companies Florida Power and Georgia Power appear throughout the exemplary screen shots shown in the drawings and the detailed description discusses the invention in terms of a “utility” being the provider of services and goods over the computer network, it should be understood that the invention is not limited to use by a single company or a single type of provider. Numerous utilities, lighting providers and suppliers, and other companies may benefit using systems and methods according to the invention.

II. Home Page and User Registration

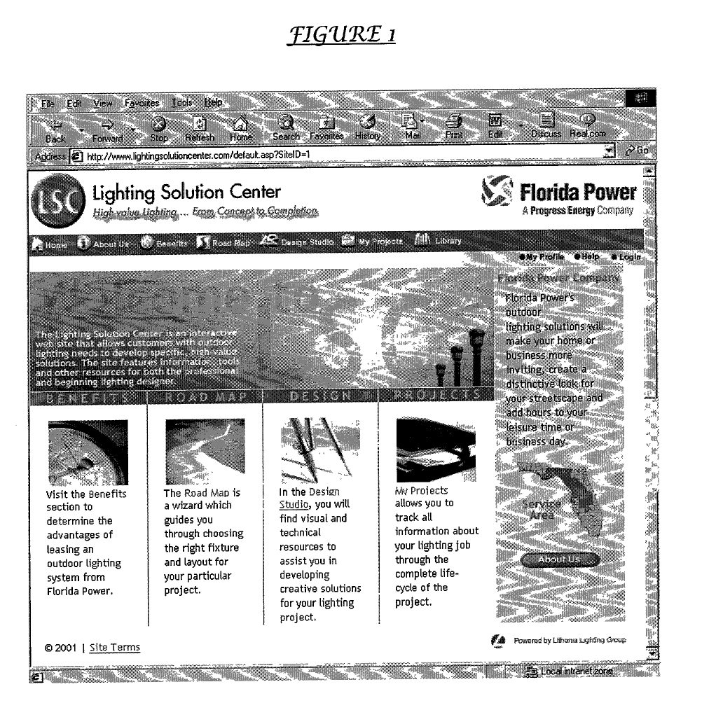

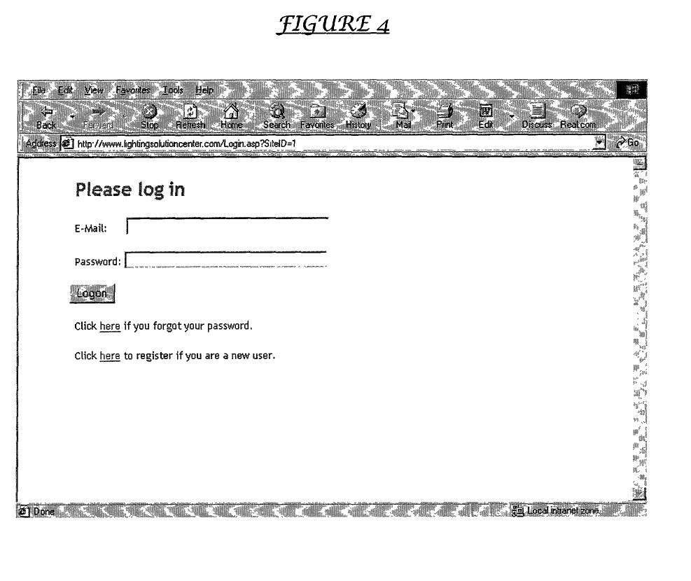

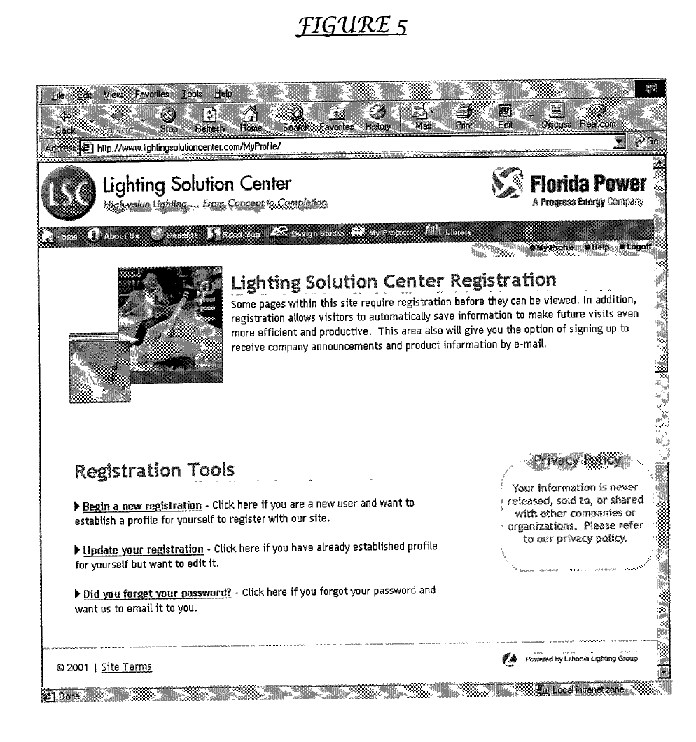

As shown in FIG. 1, when users enter the site through the utility URL, they arrive at a home page that gives them multiple choices to design lighting systems, view lighting products, view current projects, and read information about the benefits of outdoor lighting systems. Each option follows the typical progression used to select choices and ultimately define product requirements. Once users make a selection from the options shown in FIG. 1, they will be directed to a log in screen, as shown in FIG. 4. If the user is already registered, the user simply enters an e-mail address and password and proceeds to the selected destination. If the user has not previously registered, the user registers in order to view the site. FIG. 5 depicts a user registration screen through which a user may submit a new registration, update an existing registration, or request a forgotten password.

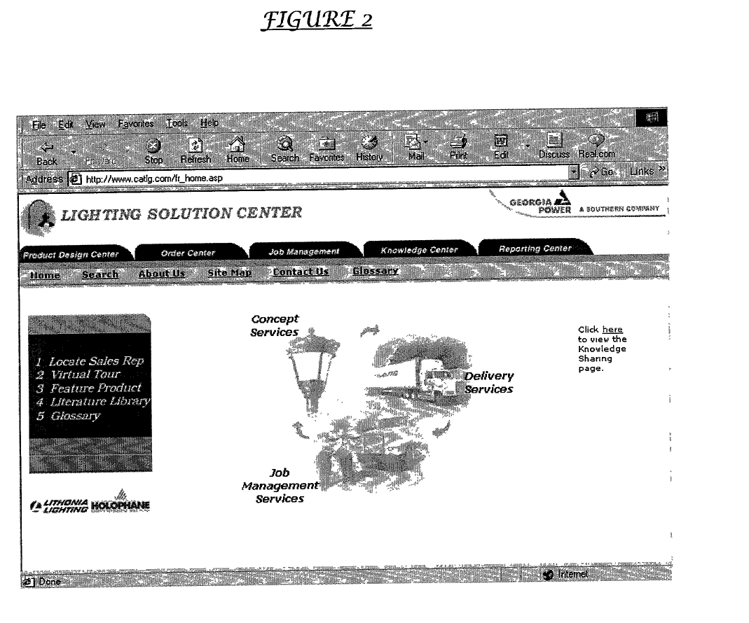

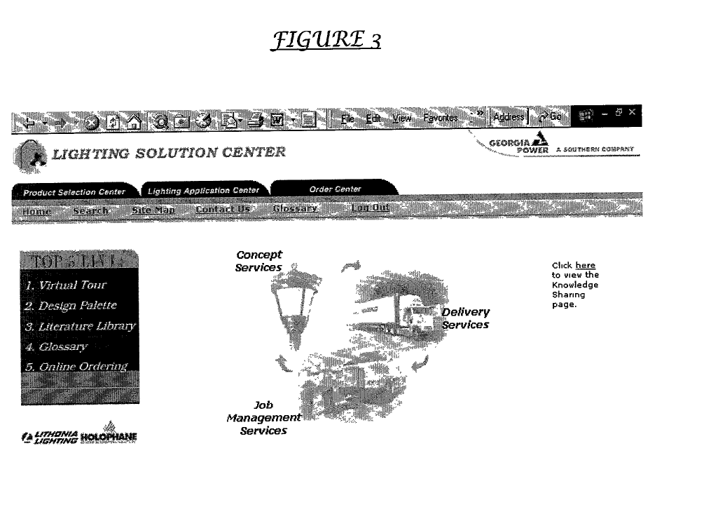

FIGS. 2 and 3 are alternate embodiments of a home page screen. As shown in FIG. 2, there are five major centers from which to choose: a product design center, an order center, a job management center, a knowledge center, and a reporting center. FIG. 3 depicts three main centers: a product selection center, a lighting applications center, and an order center.

III. Road Map Tool and Other Tools

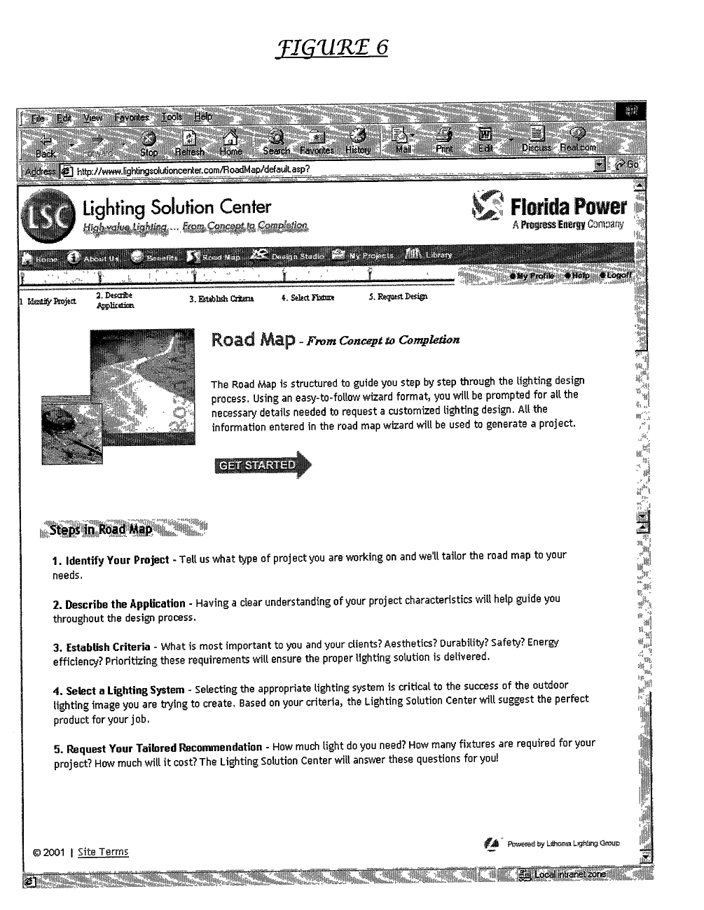

FIG. 6 shows an exemplary tool or Road Map feature according to a system of the invention. The Road Map is structured to guide users through the lighting design process in steps. Using an easy-to-follow format, users are prompted for all necessary details needed for them to request customized lighting designs, which are then used to generate proposals for lighting projects. According to a preferred embodiment of the invention, the Road Map feature includes five steps: (1) identifying a project; (2) describing the application; (3) establishing criteria; (4) selecting a lighting system; and (5) requesting a tailored recommendation.

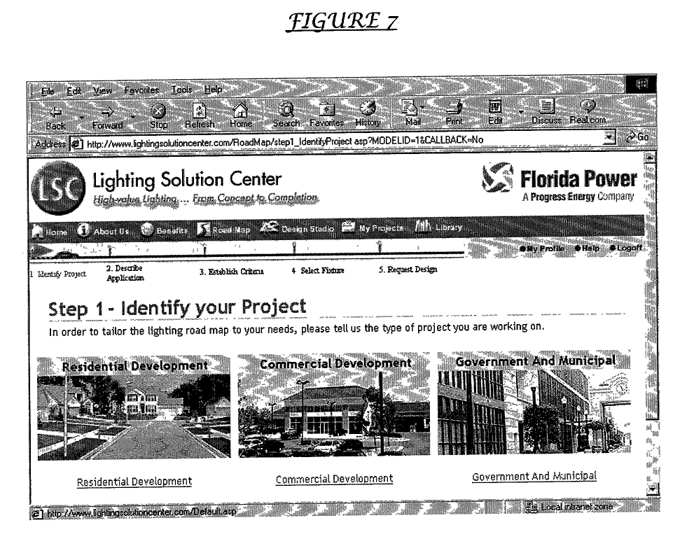

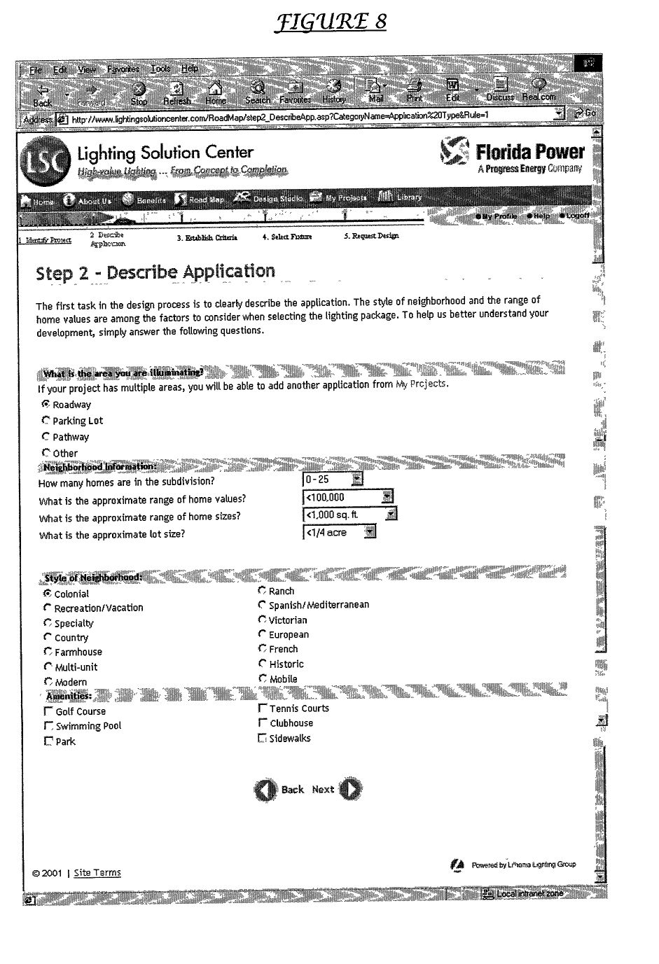

Step 1 of the Road Map is to identify the project. As shown in FIG. 7, users have three choices: residential development, commercial development, or government and municipal development. Other embodiments may contain additional categories such as indoor lighting, arena development, or others. Depending on the selection by the user, the user is prompted to enter information in step 2. For example, if the user chooses a residential development, the user is asked to describe the application, as shown in FIG. 8. The system requests, for example, information on area, neighborhood, style, and amenities. Additional or different information may be requested in step 2 in other embodiments.

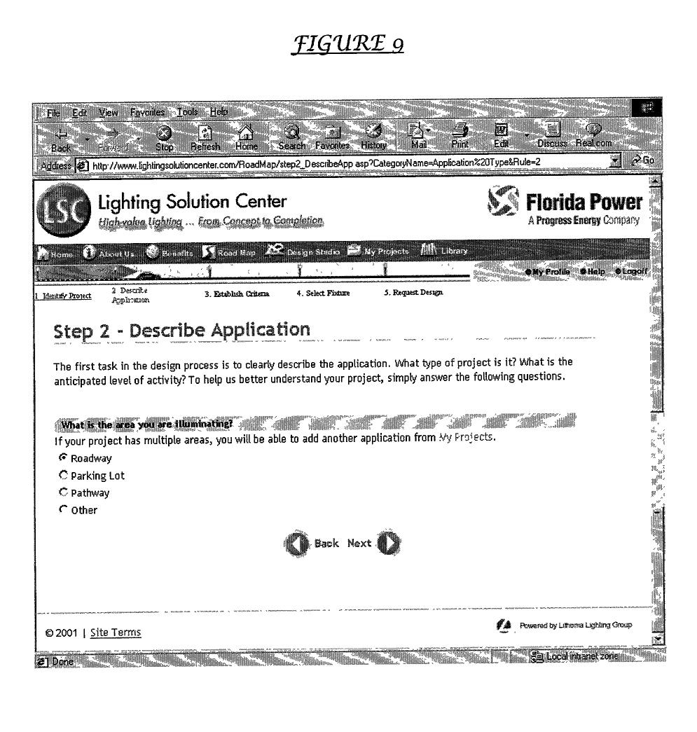

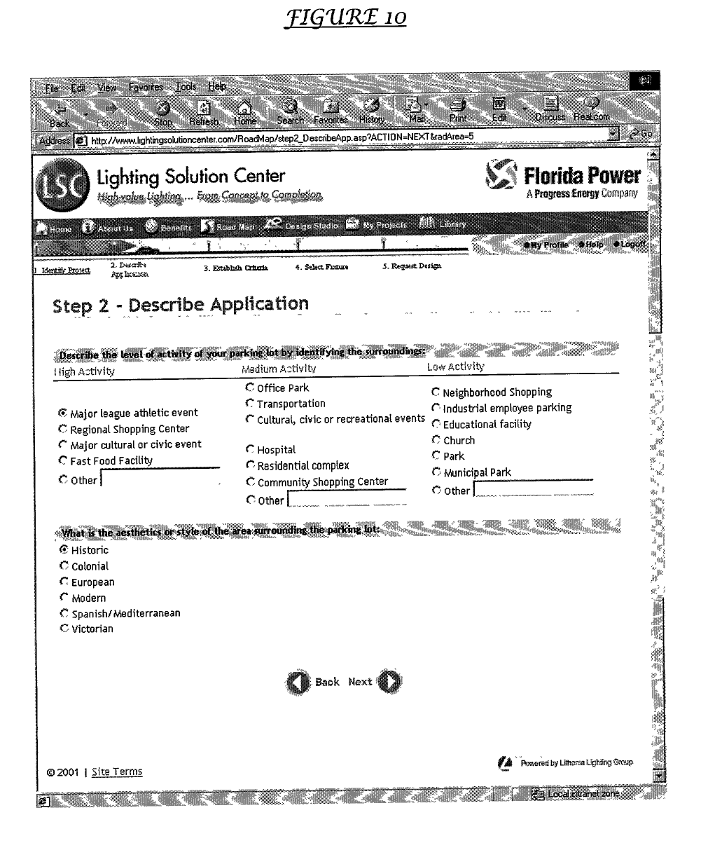

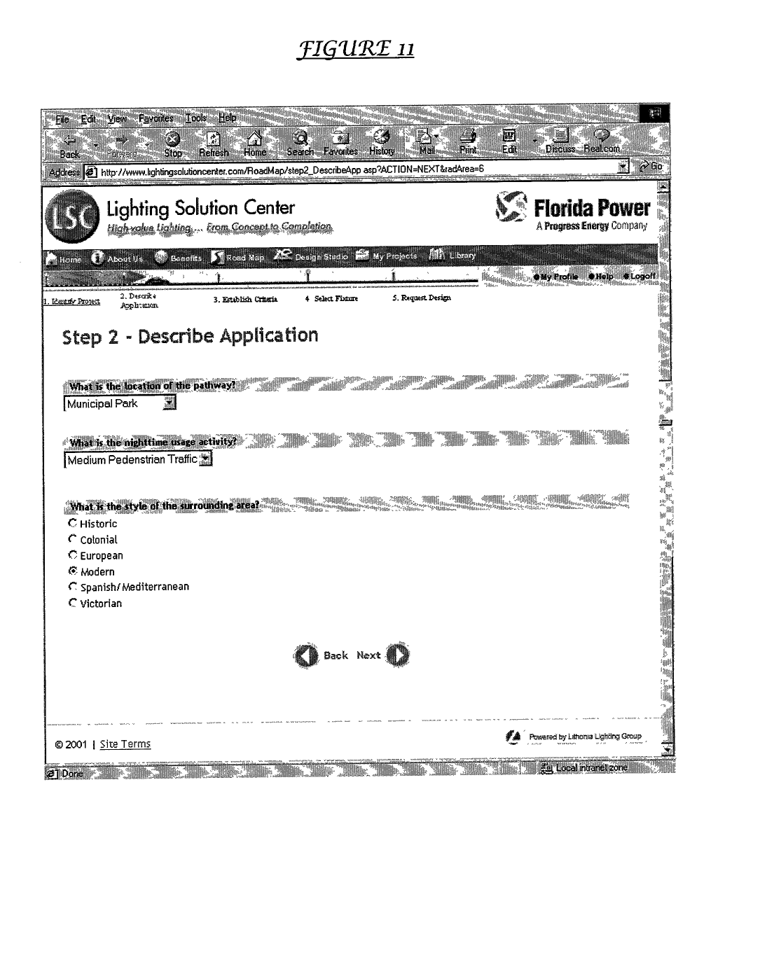

If the user selects commercial development or government and municipal, the user is prompted to describe the area being illuminated, as shown in FIG. 9: roadway, parking lot, pathway, or other. Additional categories may be provided, and further information is requested depending on the selection made by the user. For example, if the user selects commercial development and parking lot, the screen shown in FIG. 10 will prompt the user for more information about the proposed development. For a government or municipal area pathway, the user responds to the information requests shown in FIG. 11.

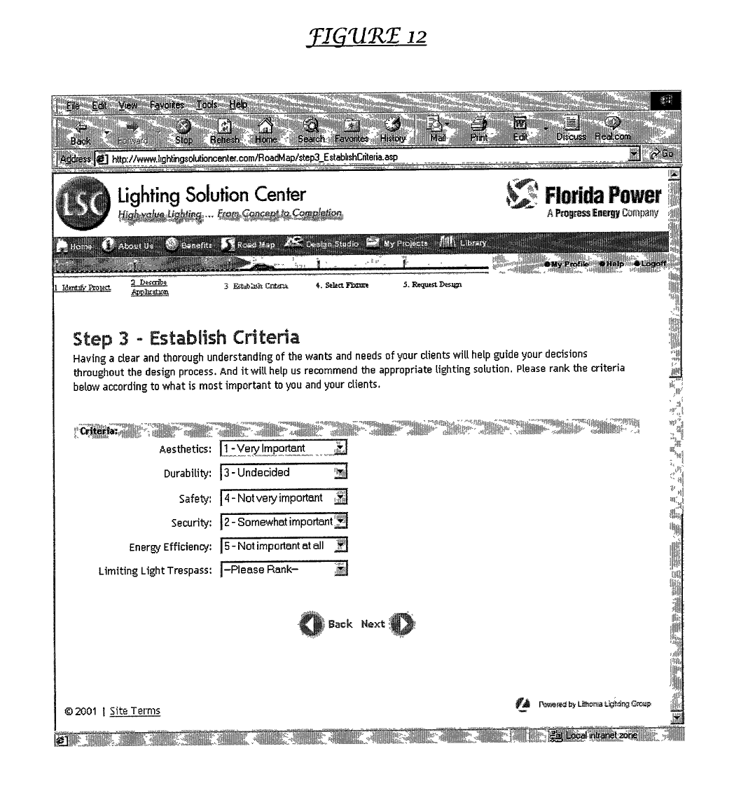

Whatever the type of development and area of illumination, step 3 involves establishing criteria for the project, as shown in FIG. 12. The user enters values indicating the importance of a set of criteria. In the exemplary screen shot in FIG. 12, the user considers aesthetics, durability, safety, security, energy efficiency, and limiting light trespass, but other or additional criteria may be provided. The user ranks the importance of each of these using a scale ranging from very important (1) to not important at all (5). Alternatively, a different numerical scale, a non-numerical ranking, or a relative ranking of each criterion may be provided by a system according to the invention.

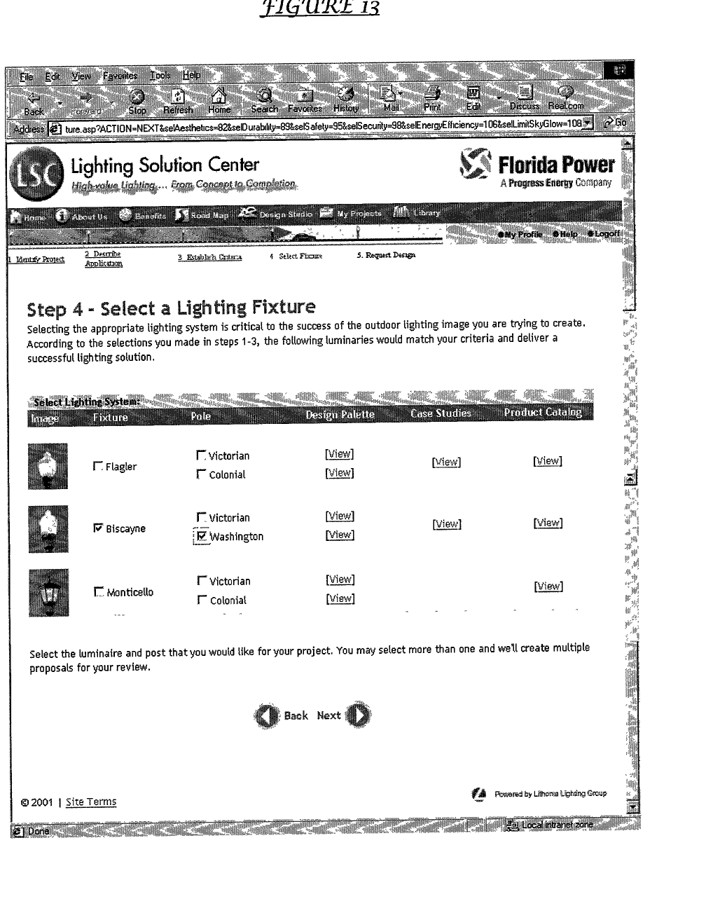

Once the user completes this step, the system returns lighting components based on the information gathered in steps 1-3. As shown in FIG. 13, the user is presented with several different options available for the particular application; for example, three possible lighting fixtures and two potential light poles for each lighting fixture as shown in FIG. 13. The user selects a lighting option, in this example one light fixture and one light pole, before proceeding to the next step. However, before the user makes a selection, the user may view the various lighting components shown in FIG. 13 by using any one or all of the three tools to the right of each choice: design palette, case studies, and product catalog. Each of these tools was briefly described in the overview above and is described in further detail below. All of these tools provide the user with the ability to view and compare the proposed lighting components before making a final selection and proceeding to step 5. Additionally, users may compare lighting components photometrically, financially, and visually by utilizing the design palette, case studies, product catalog, and other features according to a system of the invention.

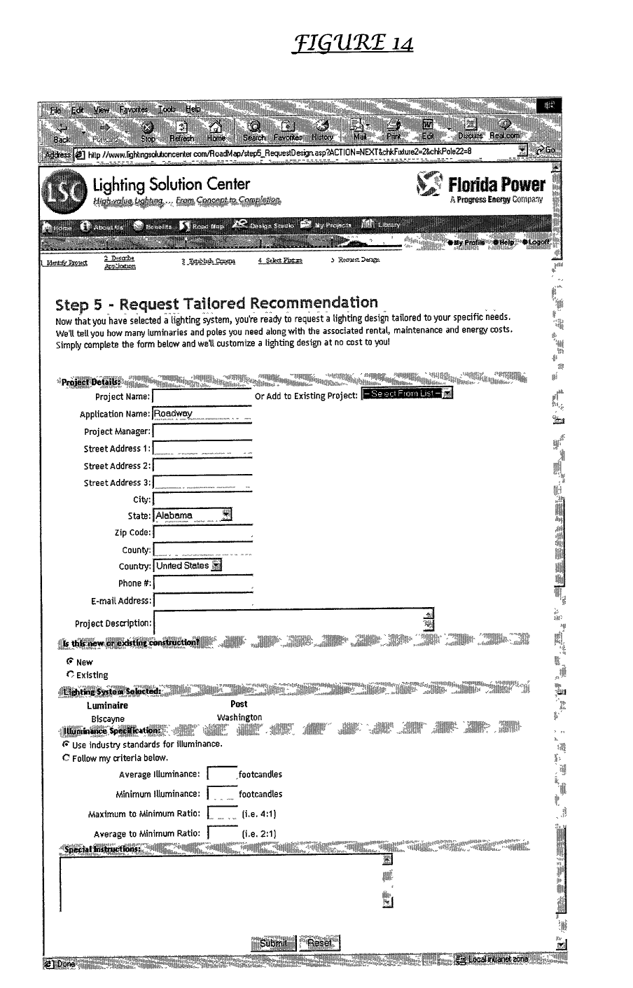

In step 5, users request a tailored recommendation for a lighting system. In an embodiment, users are prompted for general contact information, a project name, and a project description, as shown in FIG. 14. Users also indicate whether the project involves new or existing construction and any special instructions. With regard to illuminance specification, users may either use industry standards for illuminance or enter their own criteria for parameters such as average and minimum illuminance, maximum-to-minimum ratio, and average-to-minimum ratio. Completion of a form, such as that shown in FIG. 14, allows the system to generate a customized design for users that includes the number of lighting fixtures and poles required, along with the associated rental (or purchase), maintenance, and energy costs.

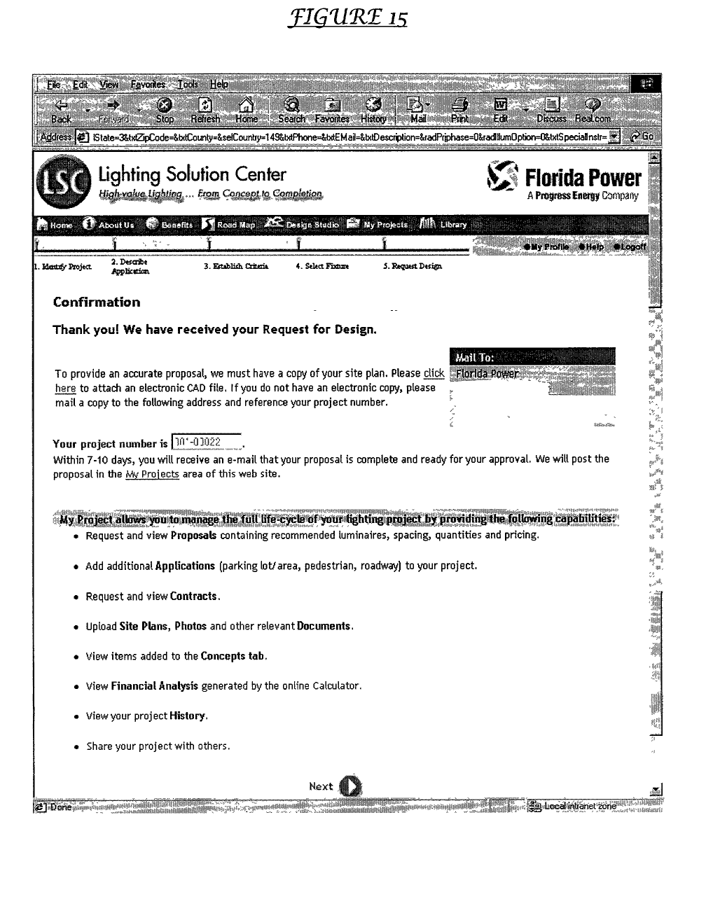

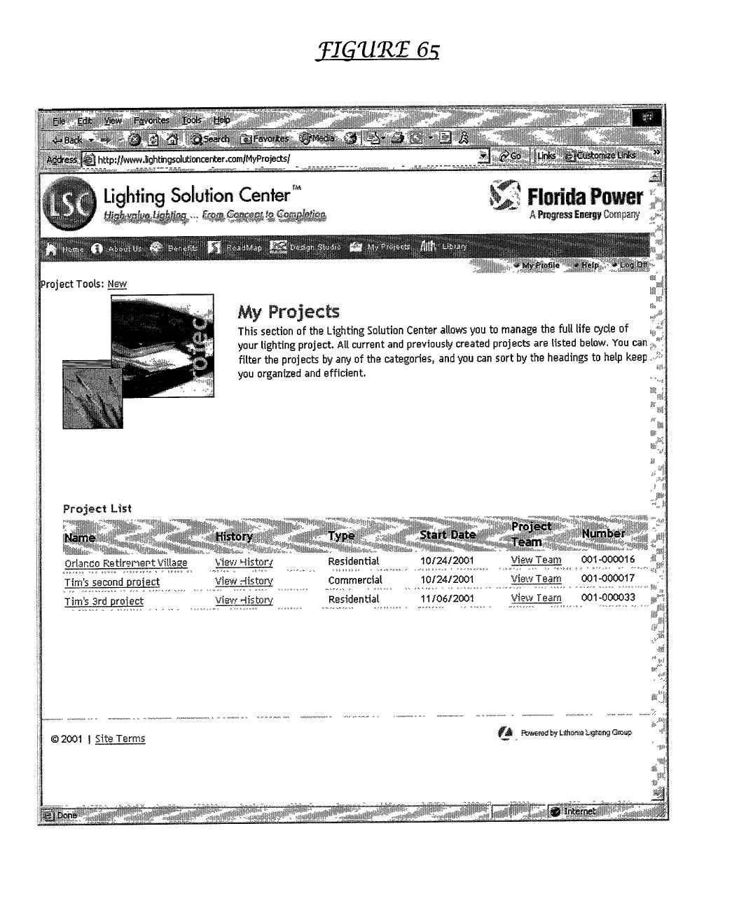

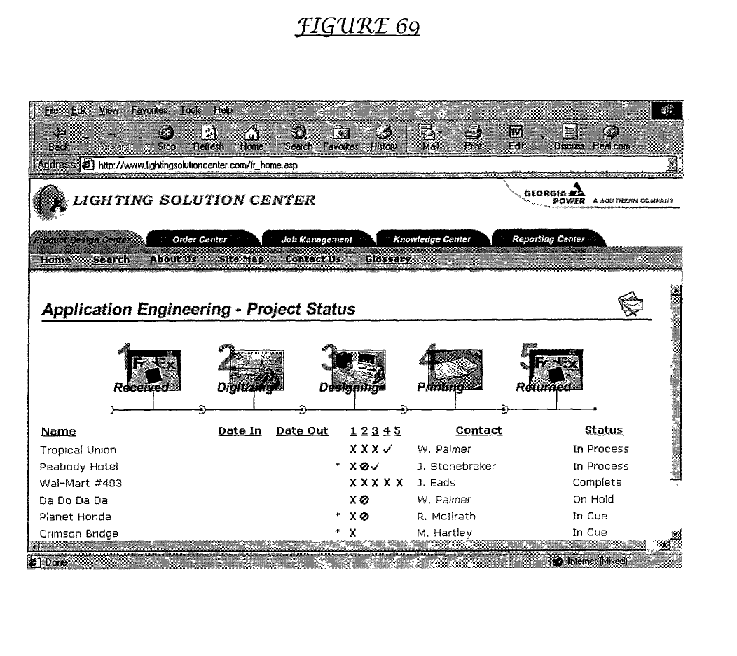

FIG. 15 illustrates a confirmation screen advising users that their requests for design proposals have been sent. The confirmation screen also provides a project number and requests that users provide a copy of their site plan, if available, either through regular mail or attaching an electronic CAD file. Submission of a site plan allows for a more accurate lighting project proposal to be prepared. The confirmation screen also contains a link to the My Projects area, as shown in FIG. 65, or alternatively FIG. 69, and described in more detail below. The customized lighting project proposal is posted in the My Projects area once the proposal is complete and ready for user approval. Users have the option of checking the status of their requests via the website and are given a projected completion date.

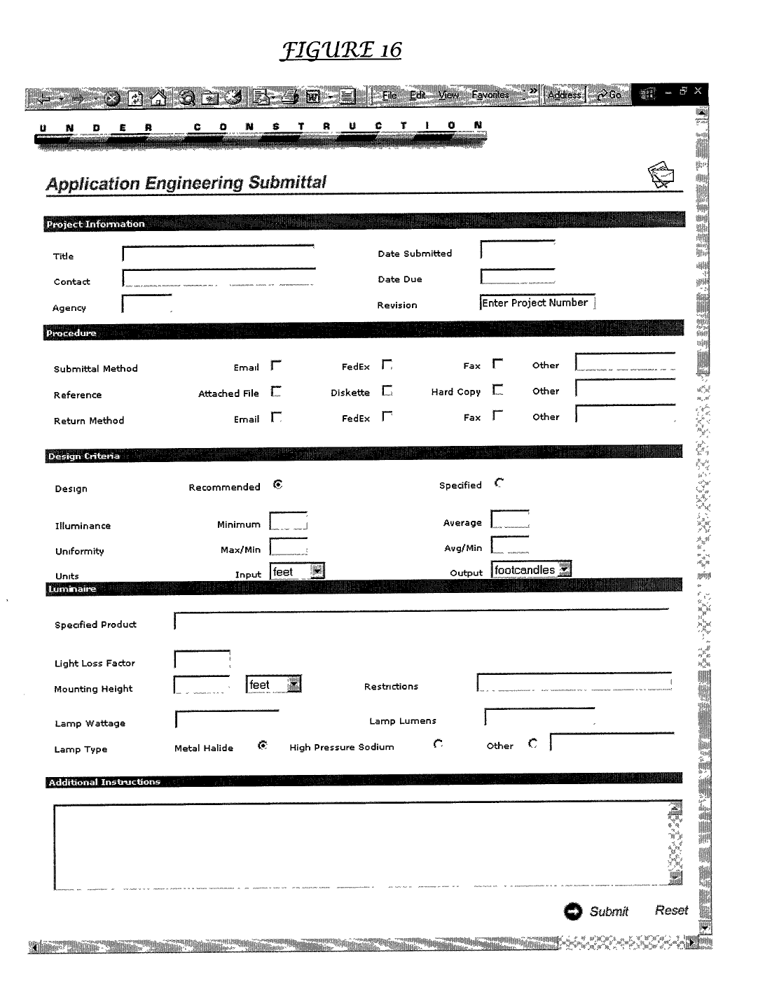

In an alternate embodiment, users have the option of submitting a project for lighting design via a computer network using a form such as that shown in FIG. 16. A user can fill in a design worksheet that defines the requirements for its application. Worksheets vary based on application and incorporate images of the products available from the utility for the type of application. Users are given the opportunity to select a product to be used or request a recommendation. Additionally, users can send electronic drawings directly to the website to be processed. Users have the option of checking the status of their requests via the website and are given a projected completion date, examples of which are shown in FIGS. 65 and 69. A response from the utility includes a lighting project design, as well as the product and financial information needed to make a decision to lease or buy the equipment. If the design is acceptable to the user, the user can lease or buy the installation through an order center according to a system of the invention.

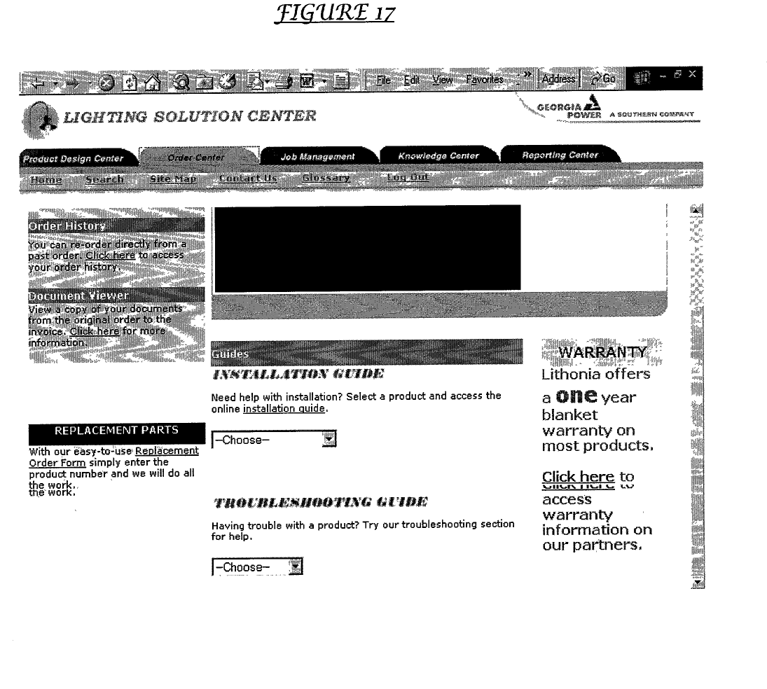

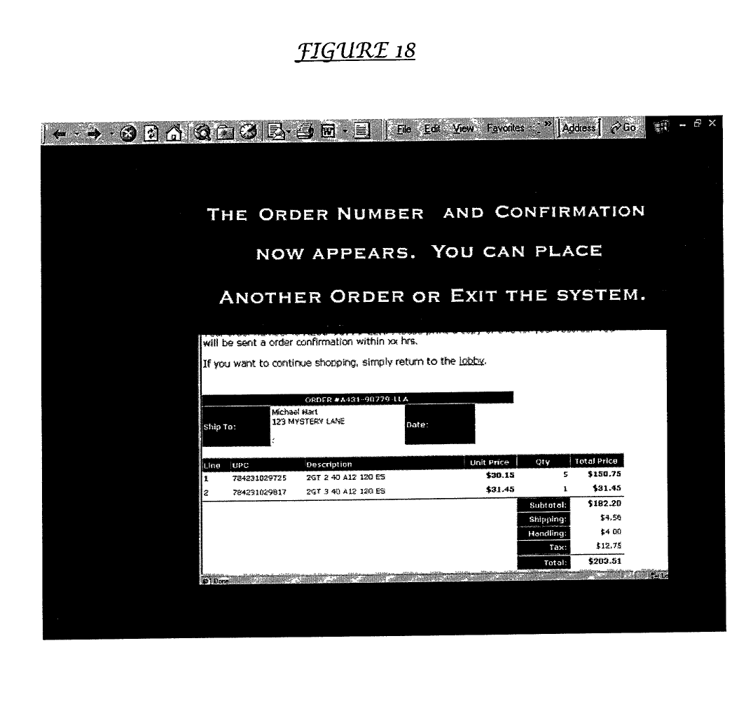

Exemplary embodiments of an Order Center are shown in FIGS. 17 and 18. Users can order equipment based on information developed in a design center, from a response to a design request submitted through the Road Map tool or an alternate embodiment, or from another source. Users also have the ability to review past projects and determine material used in order to match existing installations. Payment methods are established based on preexisting agreements with each utility. Once an order is placed, all parties to the transaction can be notified via e-mail or fax. User history may be stored for re-order opportunities.

A screen shot of a main page for the Order Center is shown in FIG. 17, while FIG. 18 depicts an order confirmation screen. In alternate embodiments, the Order Center may have additional features available only to utilities. Utility personnel may check inventory status, enter orders, check order status, request expedites, track shipments, and view order documentation on all products and services offered through the website.

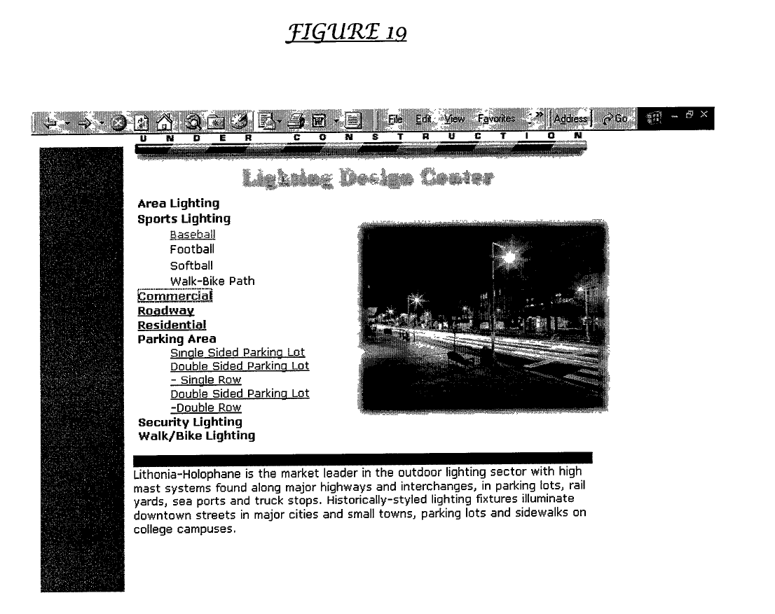

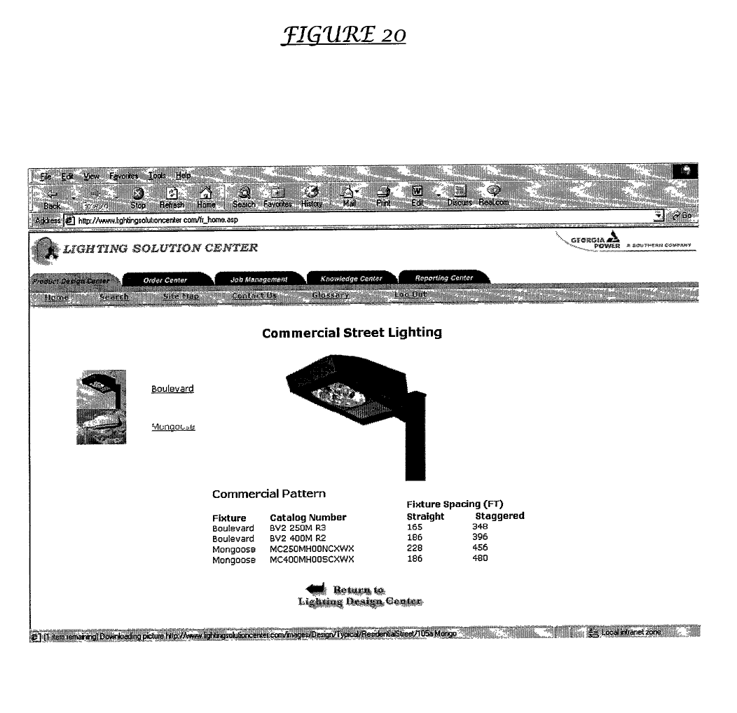

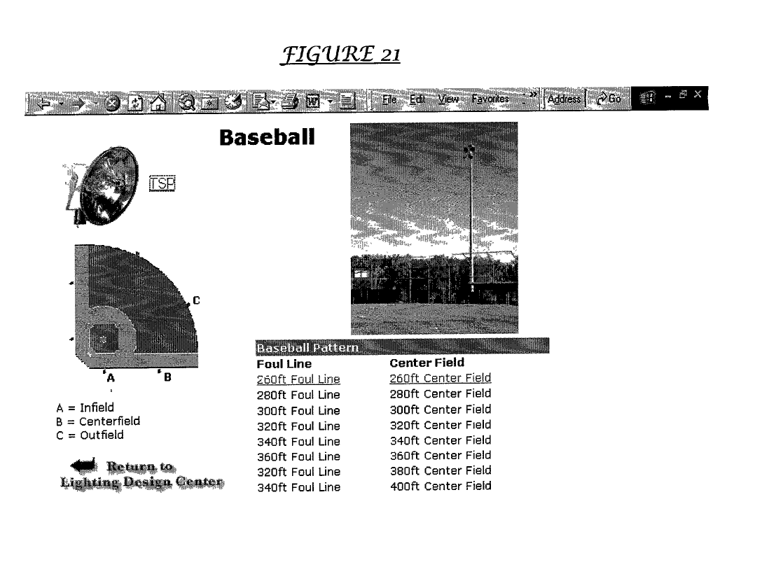

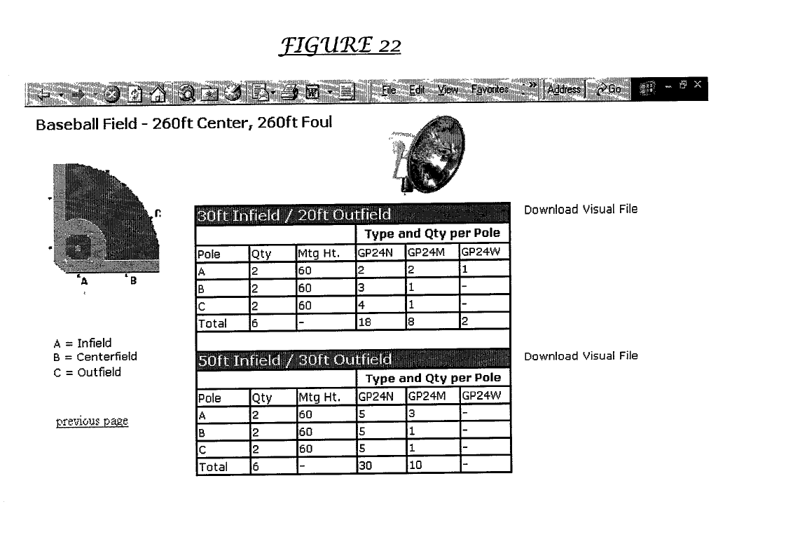

In another embodiment of a system according to the invention, users may design a project based on a specific type of application. As shown in FIG. 19, a user can visually select an application and view various lighting scenarios available from the utility. For instance, a user could select a commercial street lighting application. The user would then be presented several different lighting options available for the application. Once a type of product is selected, users can view the specific products available from the utility in the category and the performance characteristics of those products, as shown in FIG. 20. As another example, a user may choose sports lighting for baseball, as shown in FIG. 19. As shown in FIGS. 21 and 22, users may select the dimensions of the field and placement of the poles, in addition to selecting the light fixture. Alternate embodiments may include other areas such as additional outdoor or indoor sports venues, commercial buildings, parking lots, and any number of other indoor or outdoor facilities or areas.

Another page users can view (not shown) in an embodiment according to a system of the invention is an aerial view of a virtual city. By clicking on different parts of the city, users receive information about lighting scenarios for the area and are allowed to select a product type for the application. Information on the spacing of the product is displayed allowing users to determine solutions for simple lighting applications based on IES recommendations. For instance, luminaire spacing may be graphically displayed for various roadway applications, allowing users to determine the number of luminaires required.

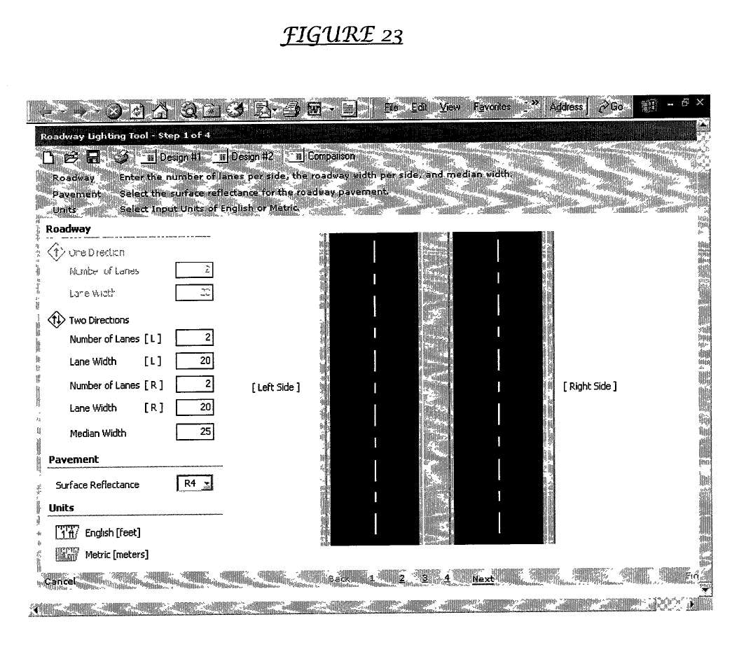

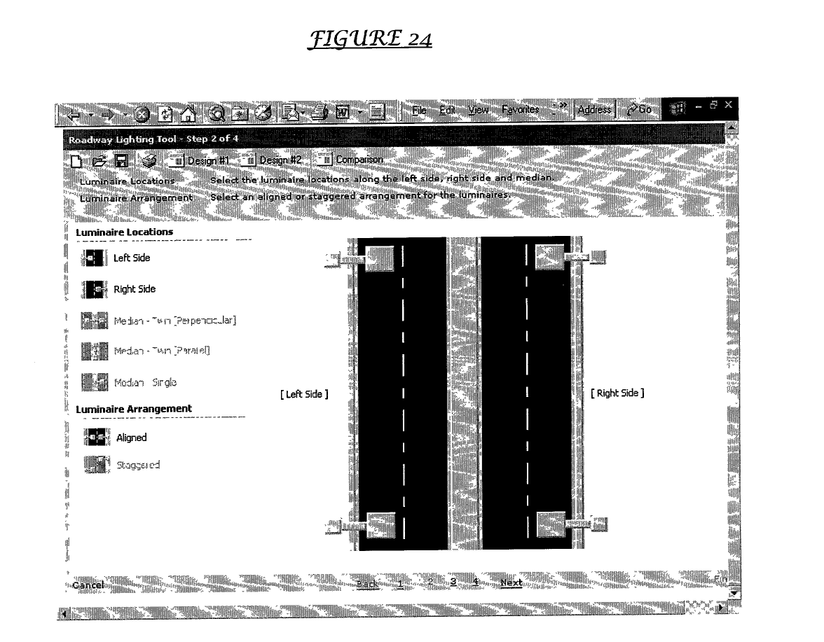

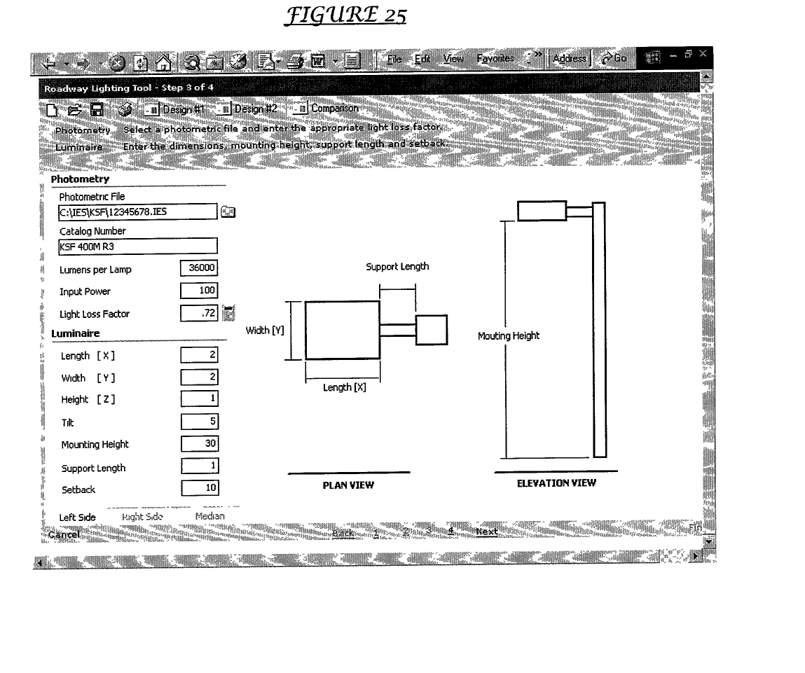

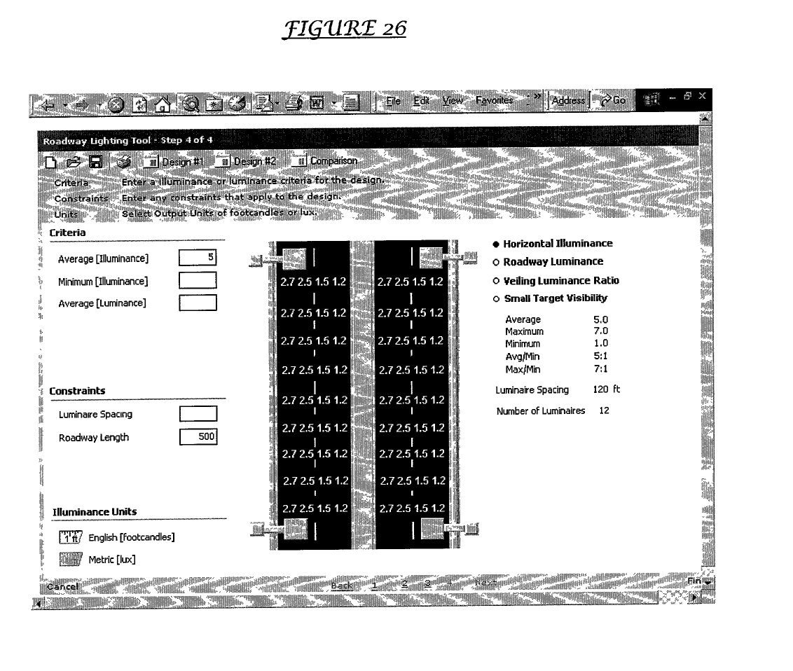

A Roadway Tool according to a system of the invention is shown in FIGS. 23-26. An exemplary embodiment shown in FIGS. 23-26 has four steps, but alternate embodiments may include different, additional, or fewer steps. The Roadway Tool allows users to follow a series of steps to choose appropriate roadway lighting. A first exemplary step generally involves entering data about the roadway and pavement, such as the number of lanes per side, the roadway width per side, the median roadway width, and the surface reflectance of the pavement, as shown in FIG. 23. A second step includes selecting luminaire locations and arrangement, as shown in FIG. 24. A third step, as shown in FIG. 25, includes entering an appropriate light loss factor from a photometric data file and choosing luminaire dimensions, mounting height, support length, and setback. FIG. 26 depicts a fourth step, which includes entering illuminance criteria for the design as well as any design constraints applicable to the lighting project. Users may create multiple designs and compare designs.

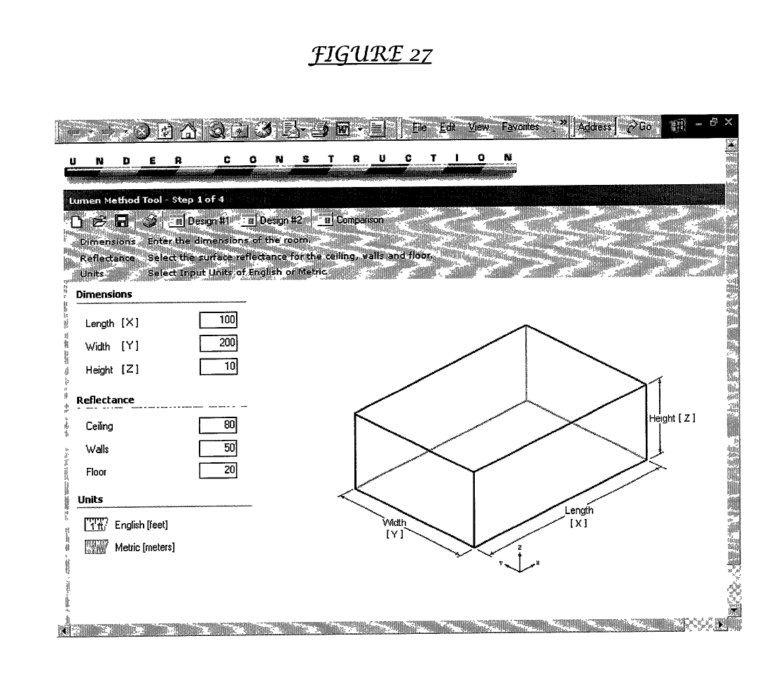

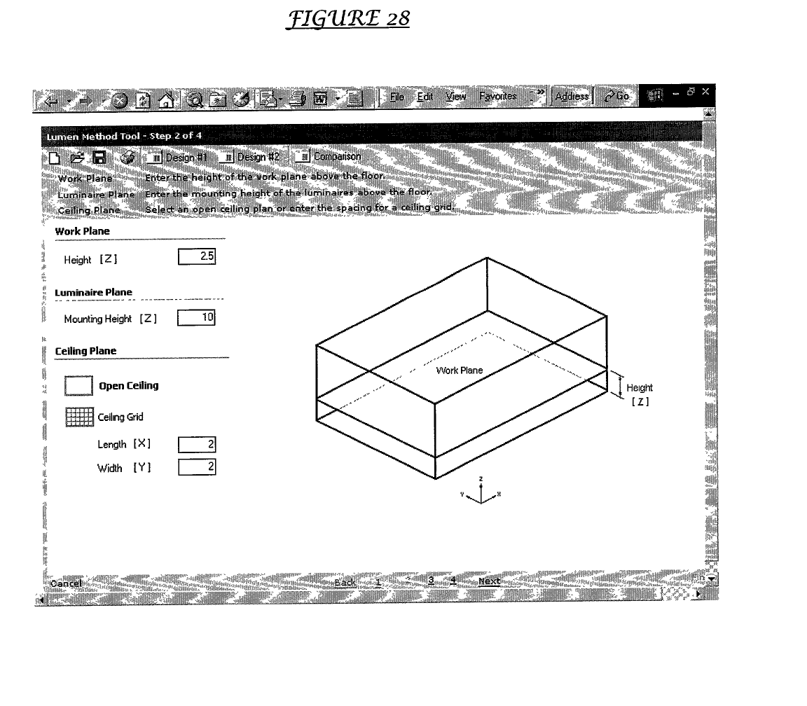

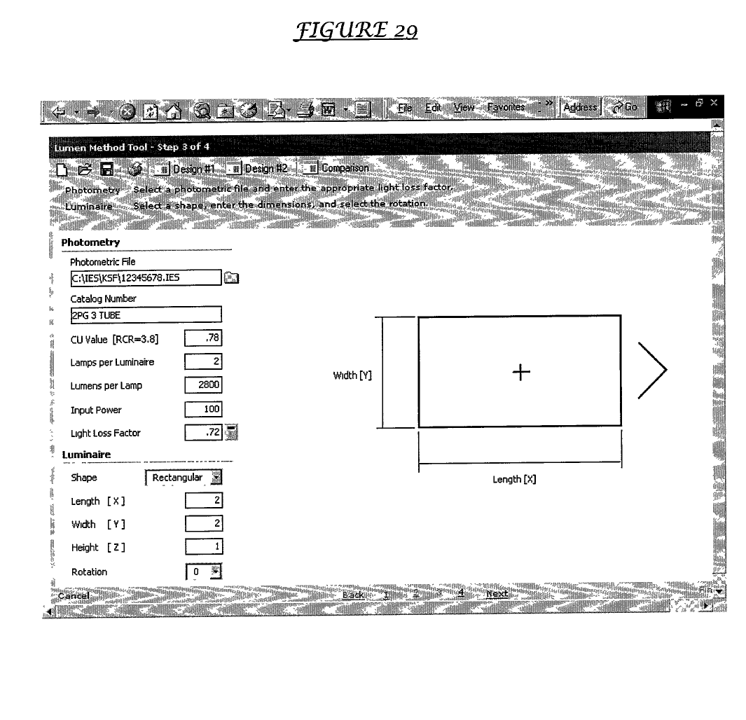

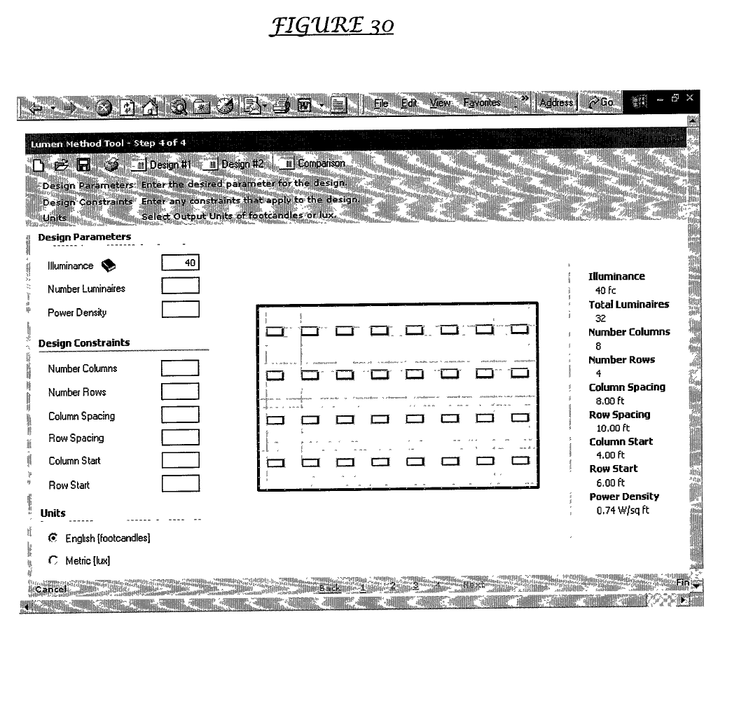

A Lumen Method Tool according to a system of the invention may also be available to users. An exemplary embodiment of the Lumen Method Tool, as shown in FIGS. 27-30, involves four exemplary steps, but alternate embodiments may include different, additional, or fewer steps. The Lumen Method Tool is applicable for interior or indoor lighting projects. A first step, as shown in FIG. 27, includes submitting the dimensions of the room and selecting the surface reflectance for the ceiling, walls, and floor. A second step involves entering the heights of the work and luminaire planes, as shown in FIG. 28. A third step, shown in FIG. 29, includes entering a light loss factor from a photometric data file and selecting a shape, dimensions, and rotation factor for luminaires. A fourth step includes providing any additional design parameters or constraints, as shown in FIG. 30. Following these steps enables users to select and design the desired interior lighting system for an interior lighting project. Additionally, users may create multiple designs and compare them.

IV. Design Studio

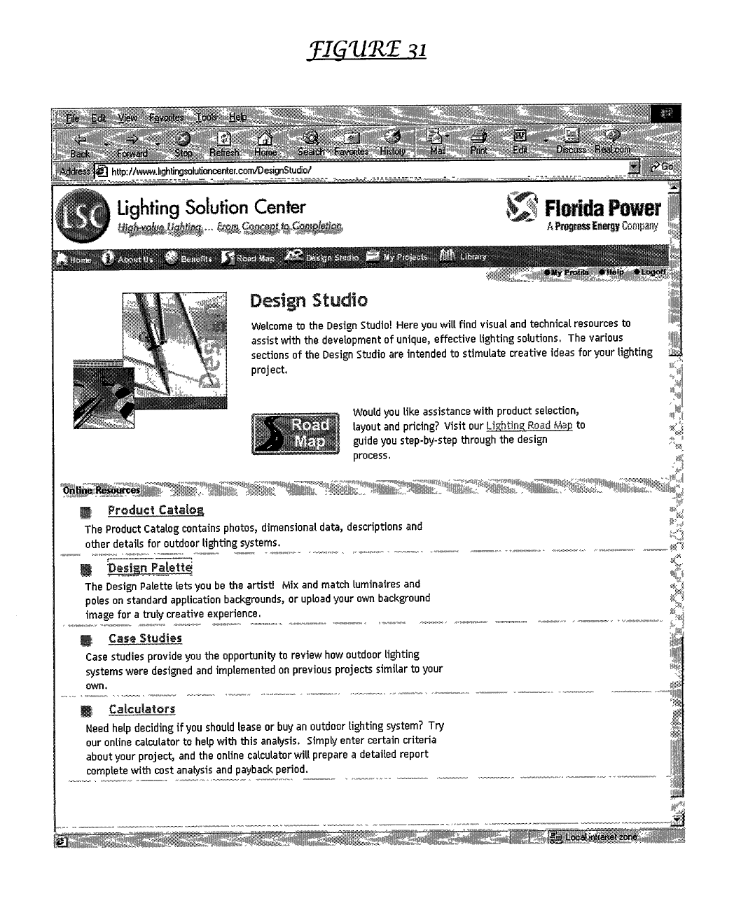

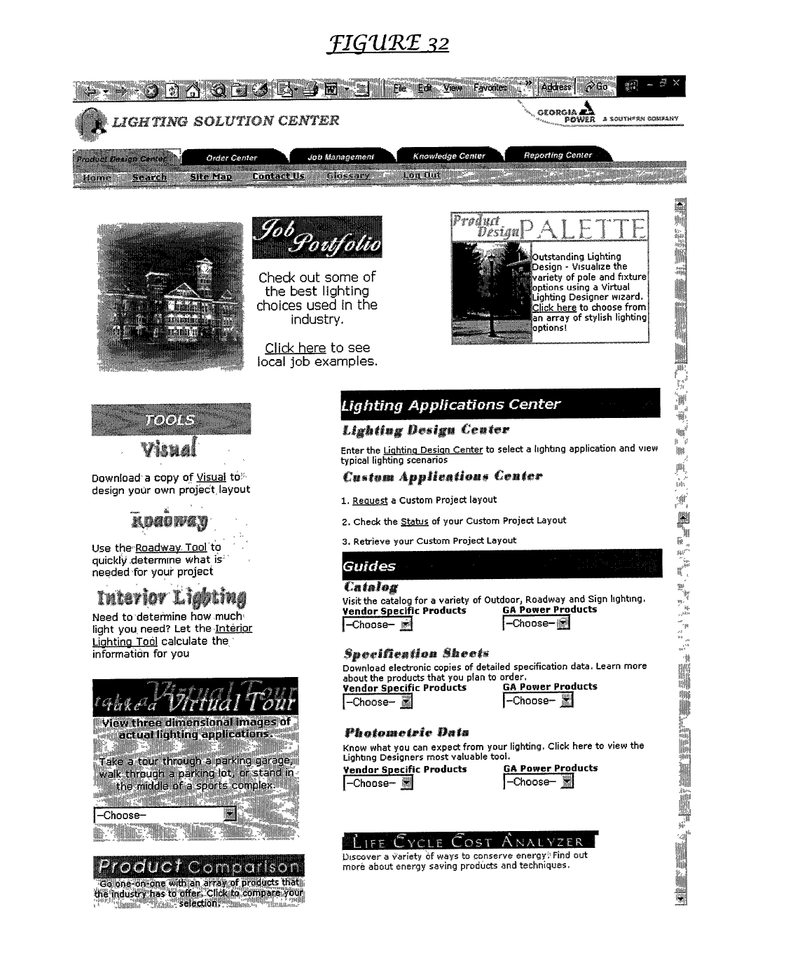

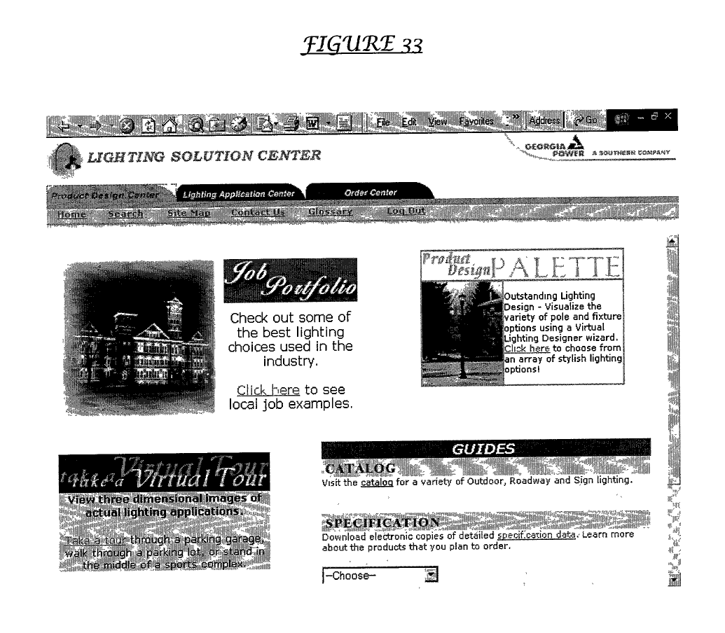

FIG. 31 shows an exemplary Design Studio feature according to a system of the invention. The Design Studio provides visual and technical resources to assist with the development of unique, effective lighting solutions. The Design Studio is not structured in a step-by-step format like the Road Map feature described above. The various sections of the Design Studio stimulate creative ideas for lighting projects. The Design Studio screen has a link to the Road Map feature of FIGS. 6-15 for those users who would like immediate assistance with product selection, layout, or pricing or those users who are looking for a more structured approach. In an embodiment according to a system of the invention, the Design Studio has four major components: a Product Catalog, a Design Palette, Case Studies, and Calculators. An alternate embodiment of the Design Studio is shown in FIG. 32 as a Product Design Center that contains many of the same components as the embodiment shown in FIG. 31, as well as links to the Roadway and Lumen Method Tools that were described above. Another alternate embodiment with fewer features is shown in FIG. 33.

A. Product Catalog

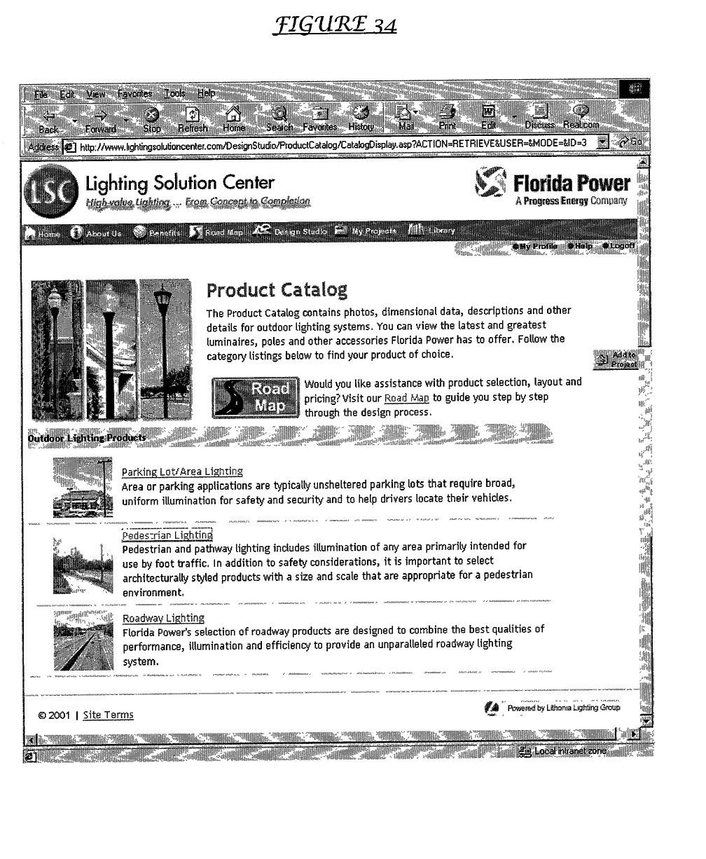

According to a system of the invention, a Product Catalog, as shown in FIG. 34, contains photos, dimensional data, descriptions, and other details for lighting products. The embodiment shown in FIG. 34 is divided into three categories: parking lot/area lighting, pedestrian lighting, and roadway lighting. Additionally, the screen shown in FIG. 34 contains a link to the Road Map tool and an “Add to Project” button linking users to current projects. The “Add to Project” button allows users to generate electronic project folders that may contain electronic documents including, but not limited to, CAD files, text files, images, and digital video. Users may upload their own documents into these folders. The folders are shared with the utility to create a collaborative workspace to support the lighting project's full life cycle. Furthermore, users can share folders with others who have an interest in the project. Project management is discussed in further detail below with reference to FIGS. 65-76.

Parking or area applications are typically unsheltered parking lots that require broad, uniform illumination for safety, security, and to help drivers locate their vehicles. For roadway lighting, performance, illumination, and efficiency are significant. Pedestrian and pathway lighting includes illumination of any area primarily intended for use by foot traffic. Although the Product Catalog is divided into three areas as shown in FIG. 34, other embodiments may contain products for other lighting applications including other types of outdoor lighting projects or any number of indoor lighting projects including, but not limited to, residential home lighting, indoor arena lighting, and office lighting.

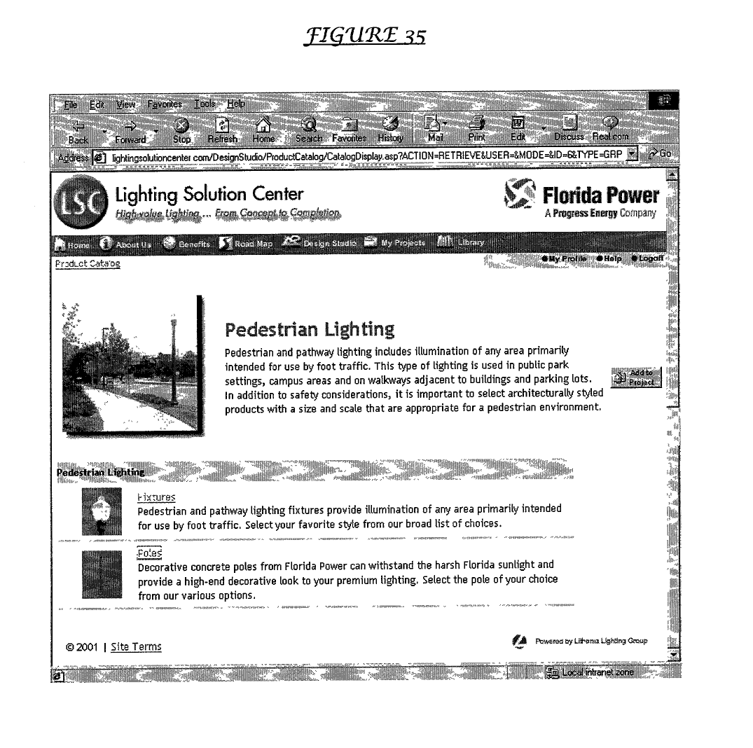

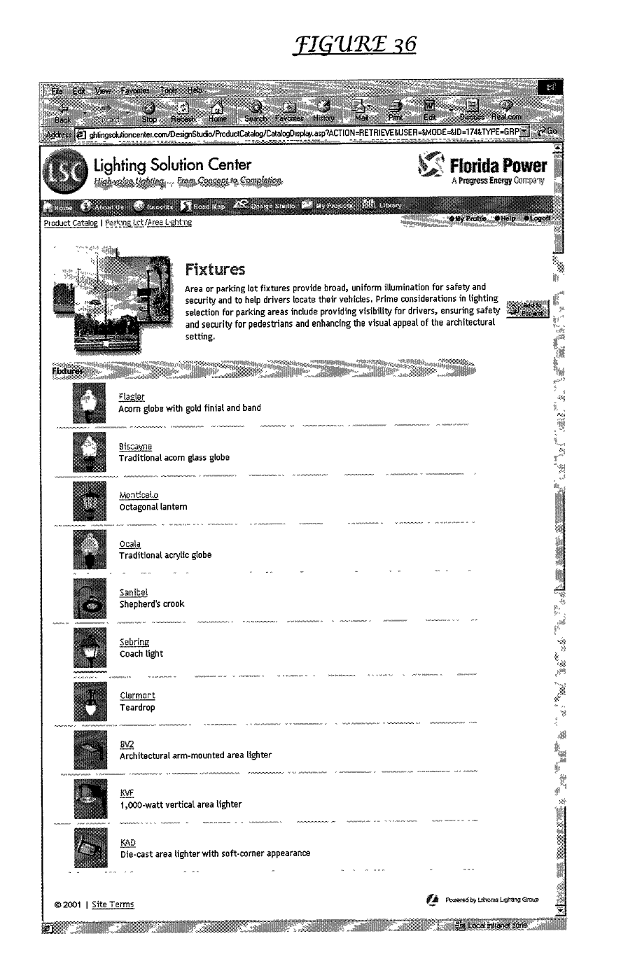

Within the Product Catalog, users can view products available and receive technical information about the product's performance including specifications and photometric data. As an example, FIG. 35 provides general information on pedestrian lighting and links to available lighting components or equipment, including lighting fixtures and light poles in this example, that are recommended for pedestrian lighting use. Similar pages for parking lot/area lighting and roadway lighting are available to users from the screen shown in FIG. 34, but are not shown. As an example, FIGS. 36-42 are exemplary screen shots of lighting fixtures and light poles available when users select parking lot/area lighting. FIG. 36 is an exemplary screen shot that provides a list of lighting fixtures available for parking lot/area lighting. Similar lists of lighting fixtures are available for pedestrian lighting and roadway lighting in the exemplary embodiment shown in FIG. 34. Such lists would include some fixtures not shown in FIG. 36, as well as omitting some fixtures shown in FIG. 36 that may not be appropriate for pedestrian or roadway lighting.

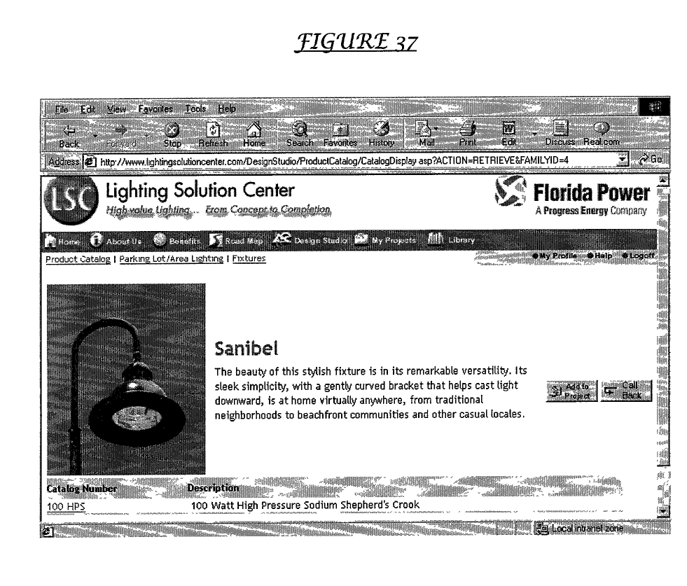

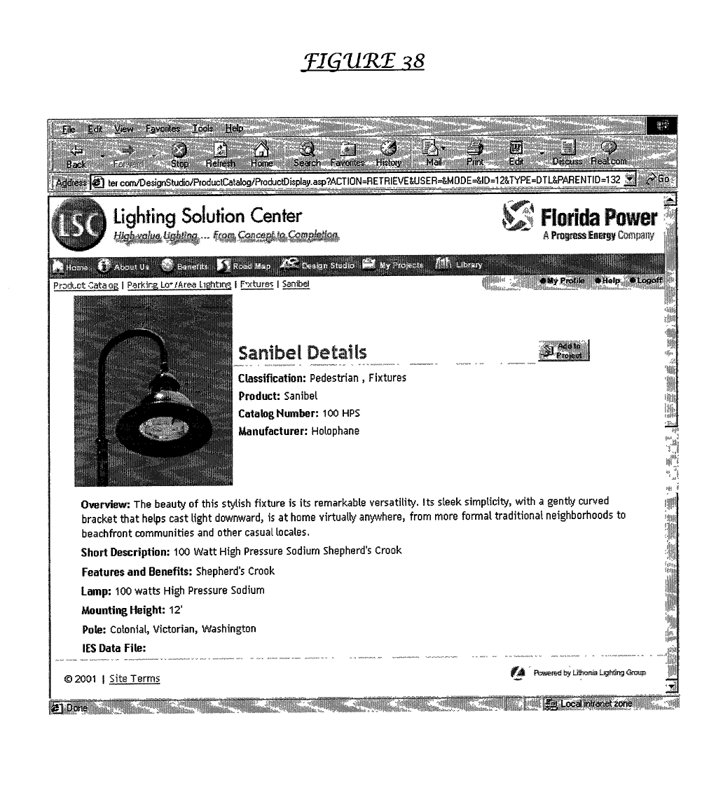

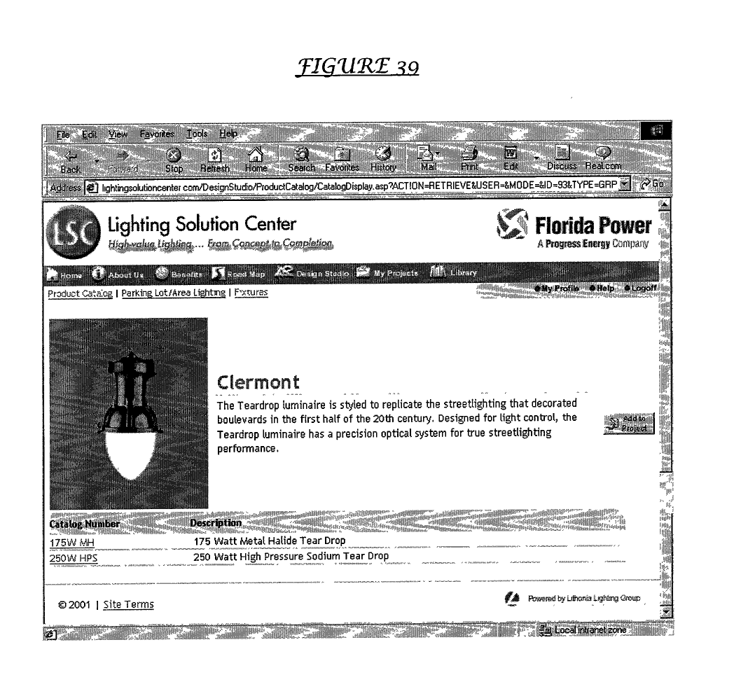

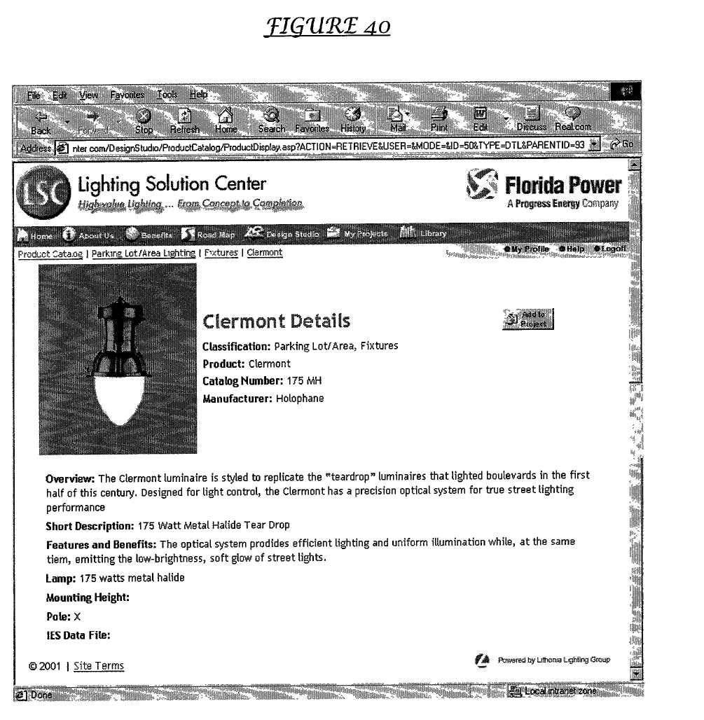

By clicking on the links provided for each lighting fixture shown in FIG. 36, users may obtain an enlarged view of each lighting fixture, as well as more information about each lighting fixture, as shown in FIG. 37. More detailed information may be obtained by clicking on the catalog number, 100 HPS in this example. Although only one catalog number is shown in FIG. 37, multiple catalog numbers may be present if multiple products are available, for example if a higher wattage version of the Sanibel fixture was also available. FIG. 38 shows detailed information for the Sanibel fixture that the user receives, including an overview, short description, features and benefits, lamp specifications, mounting height, and appropriate light poles. Another example is provided in FIGS. 39 and 40, which show the Clermont fixture. As seen in FIG. 39, there are two catalog entries for the Clermont fixture, and detailed information for the 175W MH entry is shown in FIG. 40.

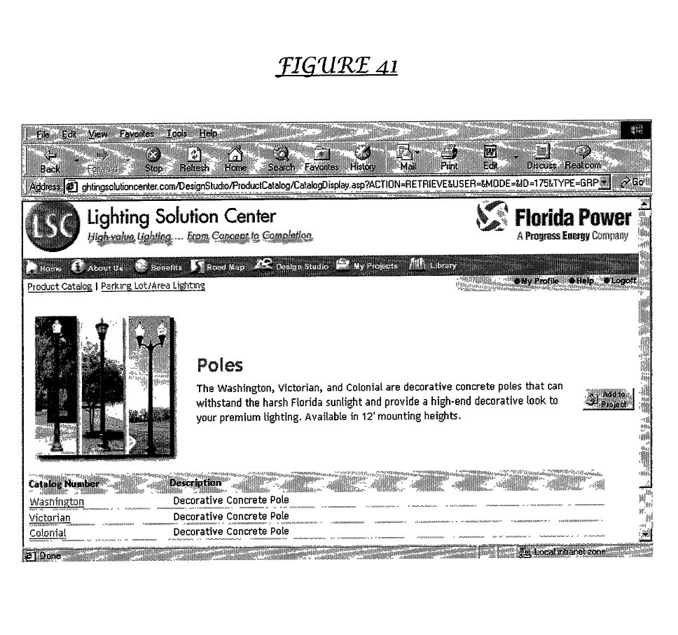

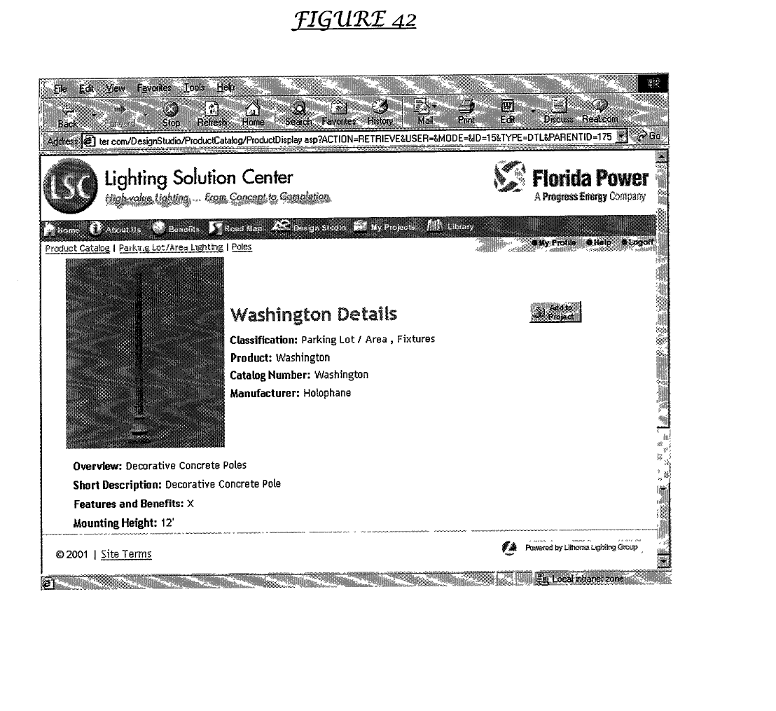

FIG. 41 is an exemplary screen shot that provides a list of light poles available for parking lot/area lighting. Similar lists of light poles are available for pedestrian lighting and roadway lighting in the exemplary embodiment shown in FIG. 34. Such lists may include some poles not shown in FIG. 41, as well as omitting some poles shown in FIG. 41 that may not be appropriate for pedestrian or roadway lighting. By clicking on the links provided for each light pole shown in FIG. 41, users may obtain an enlarged view of each light pole, as well as more information about each light pole, as shown in FIG. 42. The above-described screen shots for lighting fixtures and light poles are exemplary, and alternate embodiments include, but are not limited to, luminaires, indoor light fixtures, light bulbs, and other types of lighting products or lighting equipment.

B. Design Palette

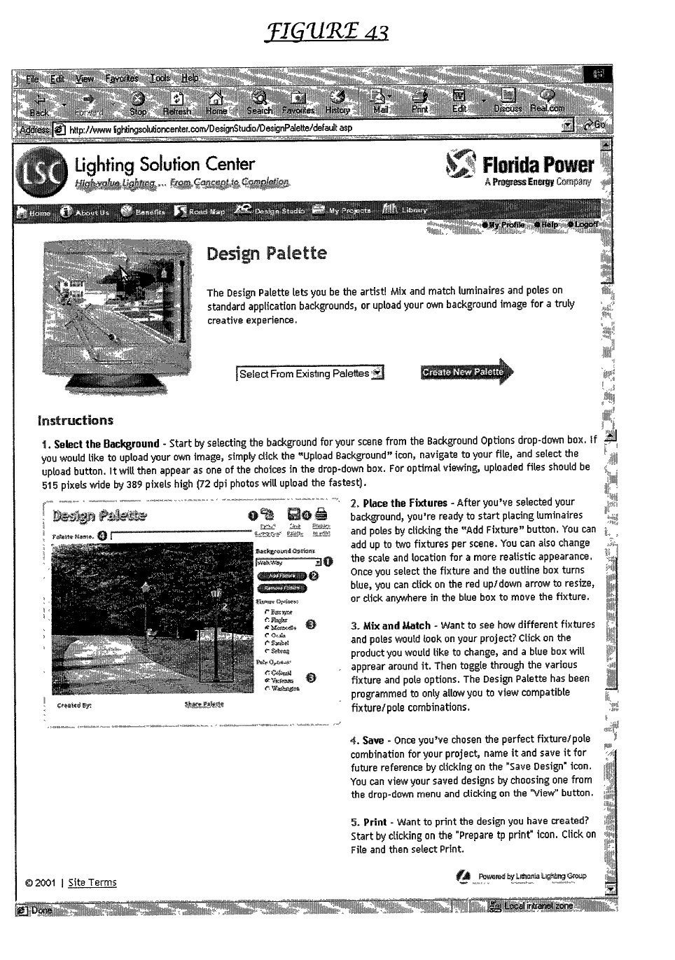

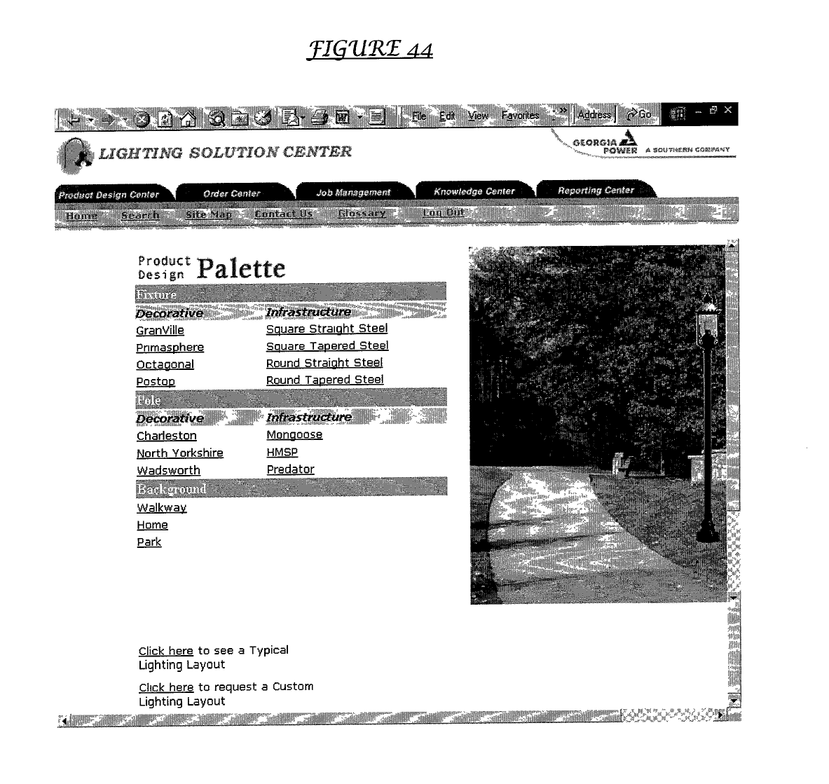

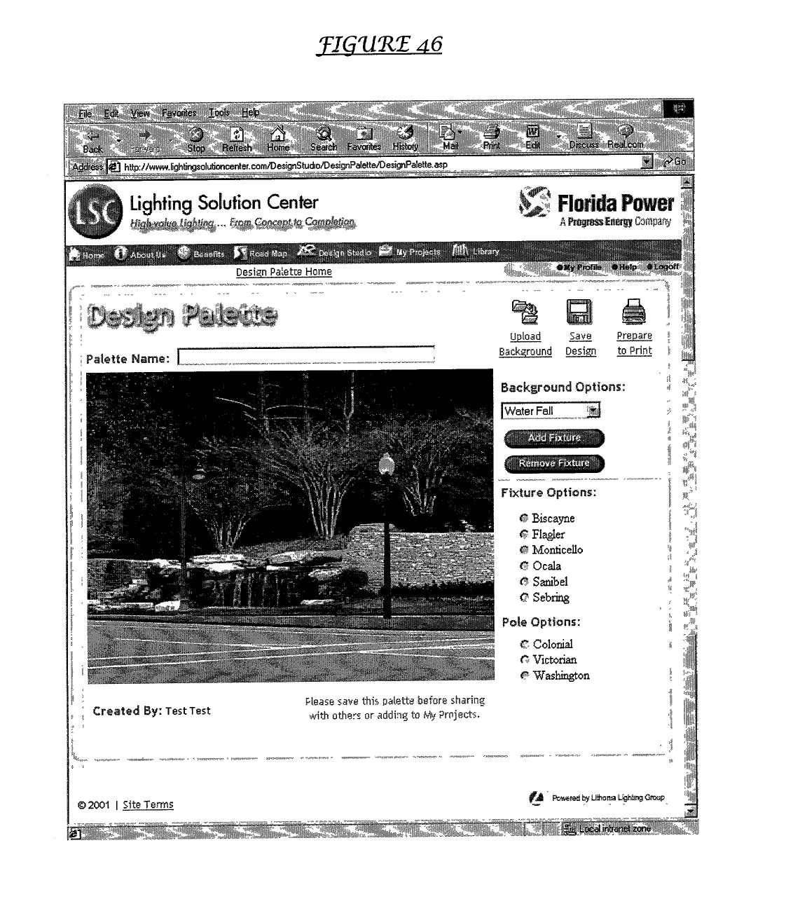

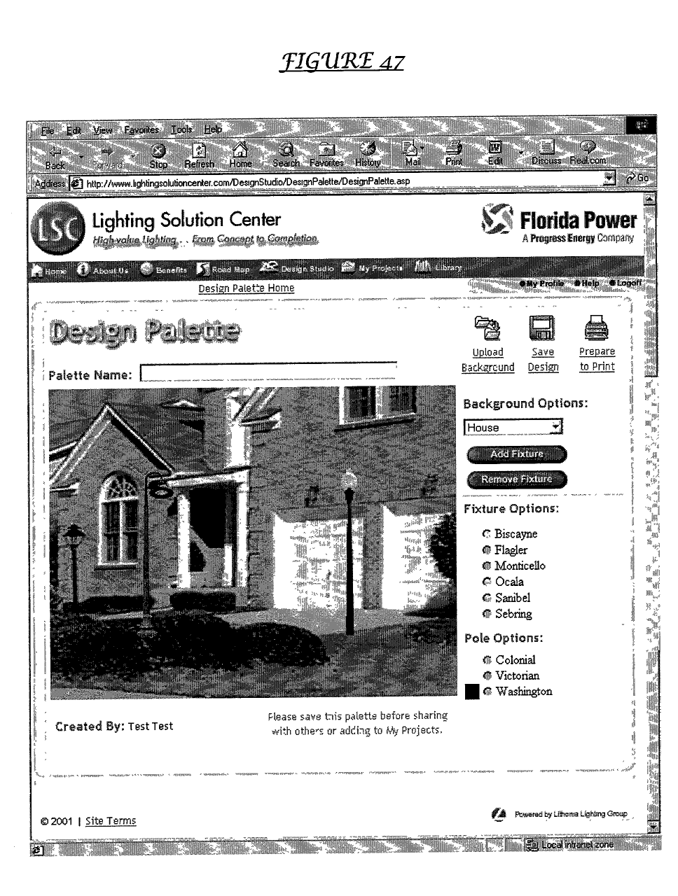

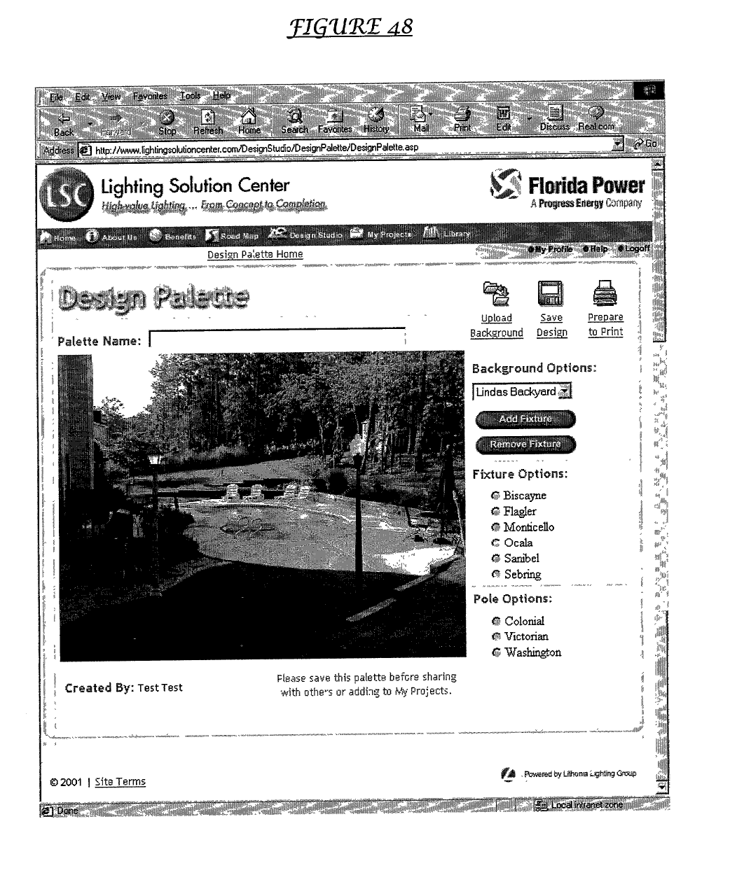

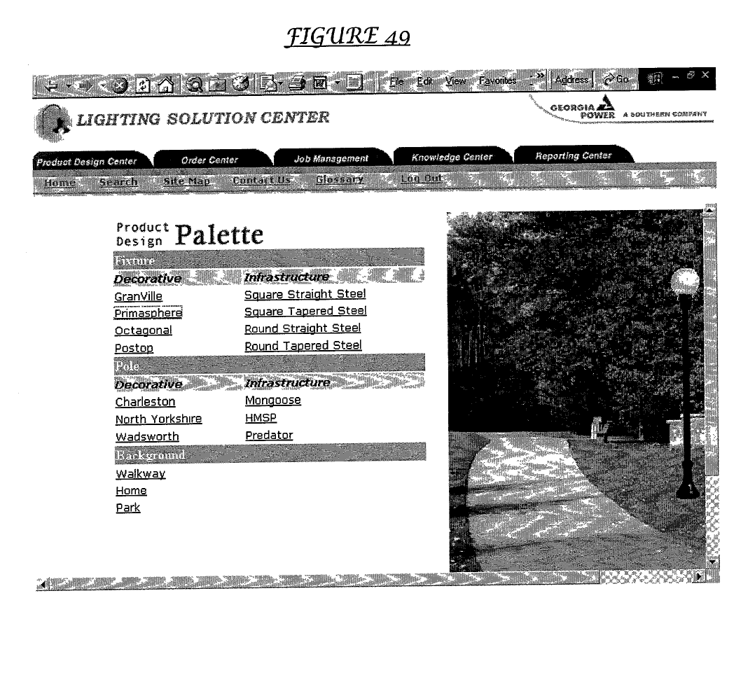

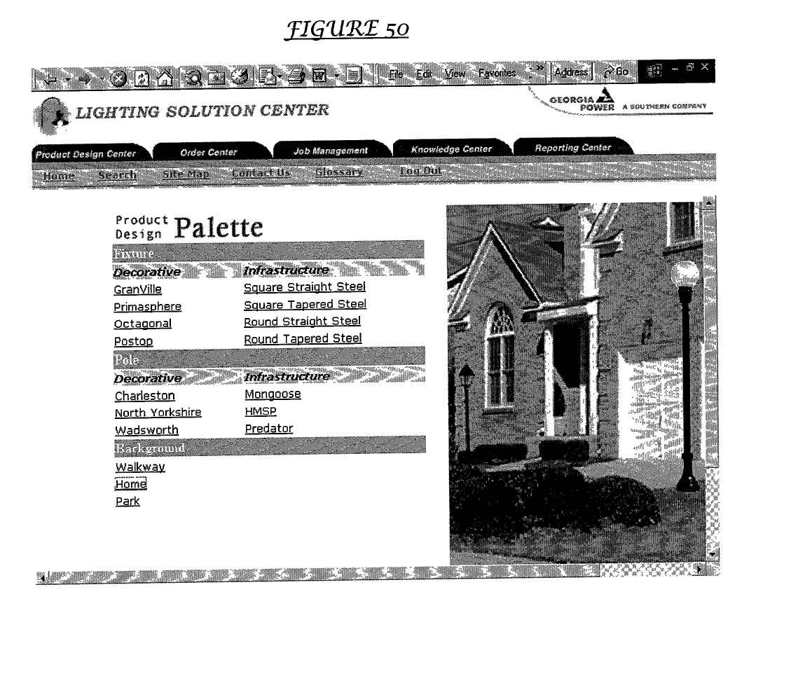

As shown in FIGS. 43-50, a design center or design palette according to a system of the invention allows users to mix and match lighting components (lighting fixtures and light poles in the exemplary embodiments shown) on standard application backgrounds or personal uploaded background scenes. Instructions for using the Design Palette are shown in FIG. 43. An alternate embodiment without any instructions is shown in FIG. 44. Initially, users select the background scene from the Background Options drop-down box, which typically includes options such as house, walkway, waterfall, and more. Users can also upload their own background scene images by clicking the “Upload Background” icon, navigating to the file to be uploaded, and selecting the upload button. The uploaded background will then appear as one of the choices in the drop-down box. This valuable feature allows users to view lighting components in a personalized background in order for them to have more definite ideas about how a particular lighting option will look in the context of their lighting project.

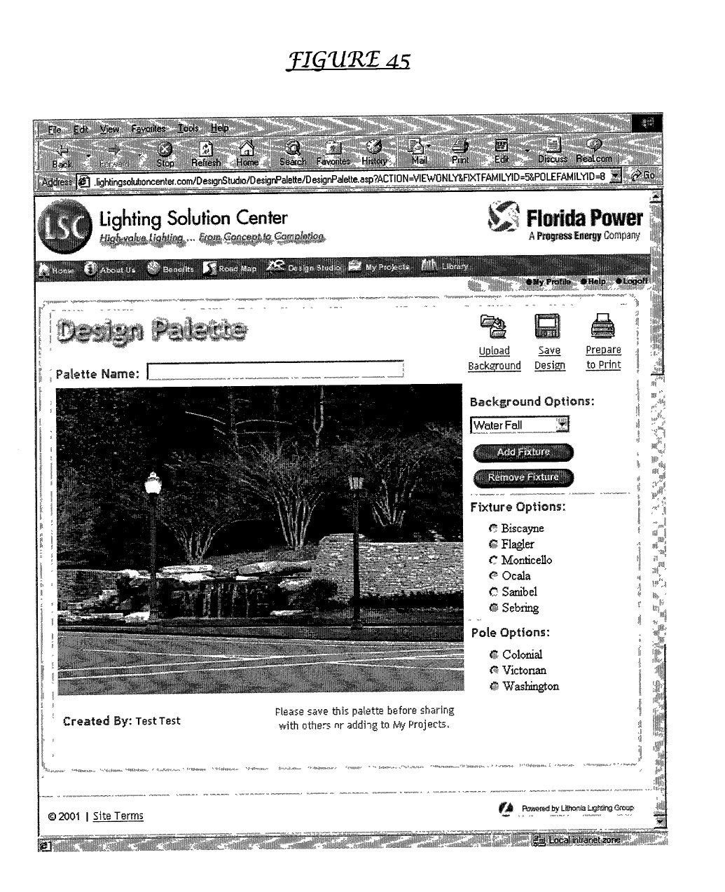

After a background has been selected, users can place lighting components, light fixtures and poles in the exemplary embodiments shown, by selecting the “Add Fixture” button. In the exemplary embodiments shown in FIGS. 45-50, one or two fixture and pole combinations can be added per scene, although alternate embodiments may allow for many more fixture and pole combinations, or other lighting components, to be added to a background scene. The scale and location of each lighting component can be changed as well. Once a fixture and pole combination is selected, an outline box appears around the combination, as shown in FIG. 43, and users can click on an up/down arrow to resize or click anywhere within the outline box to move the fixture and pole combination. In other embodiments, different methods may be used to allow users to move and/or resize lighting components.

To see how various lighting components appear, users click on the product they would like to change and an outline box appears around it. Users may then toggle through the various lighting components. In a preferred embodiment, the Design Palette is programmed to only allow users to view compatible lighting components, such as the fixture and pole combinations in the exemplary embodiments. With the Design Palette, users can obtain a highly visible and accurate depiction of how the desired lighting component(s) appear when installed in a particular setting. Examples of various combinations of lighting components and background scenes are shown in FIGS. 45 through 50. Although the exemplary embodiments described above include lighting fixtures, light poles, and backgrounds for outdoor lighting, it should be understood that alternate embodiments are contemplated and include, but are not limited to, luminaires, light bulbs, indoor lighting fixtures, and other indoor and outdoor lighting equipment, as well as various indoor and outdoor backgrounds such as rooms of residential homes, interiors of office and professional buildings, sports arenas, sports fields, warehouses, and restaurants.

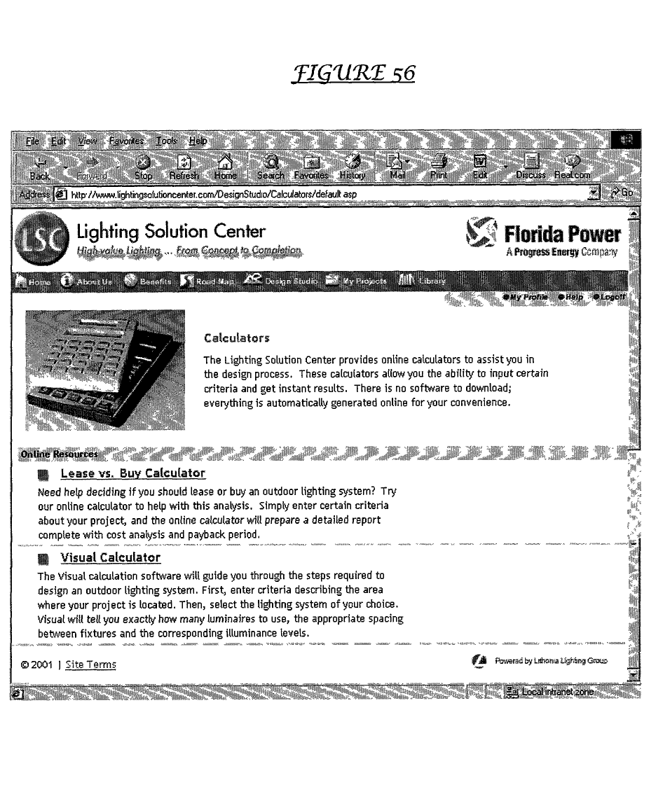

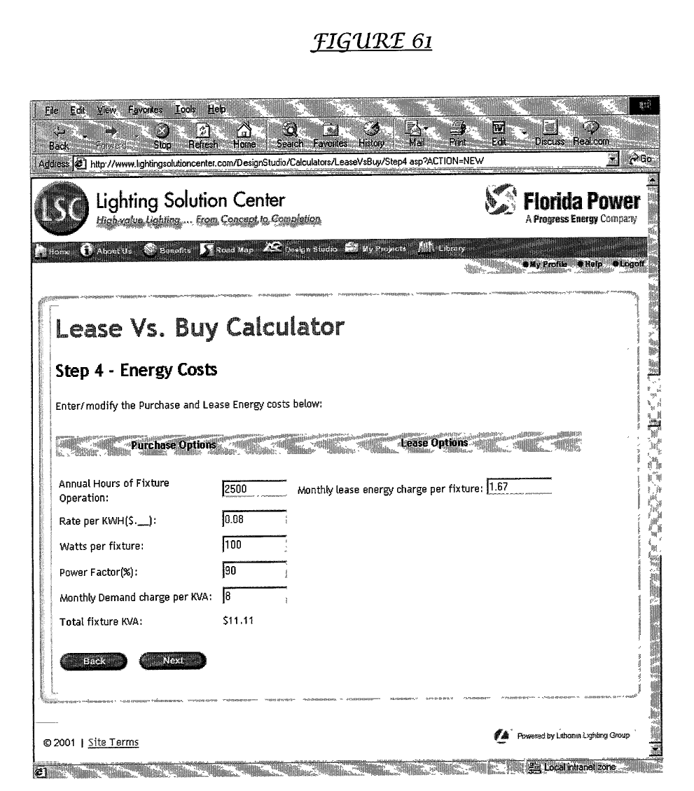

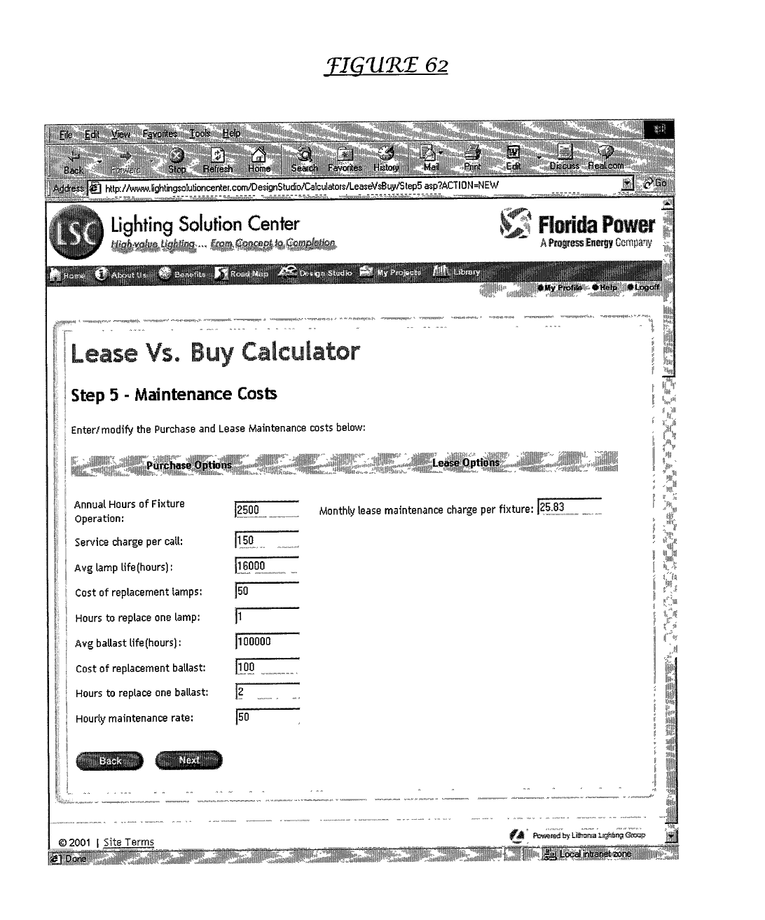

In an additional embodiment of a system of the invention, the design center or palette enables users to perform product and cost comparisons. The product comparison allows users to view side-by-side comparisons of different types of lighting products. Users may enter the comparison page directly or by linking from other areas. In the cost comparison area, users compare various lighting systems and determine the costs of owning and maintaining their own systems versus leasing the lighting systems from the utility. Alternatively, users may utilize the lease/buy calculator described below with reference to FIGS. 56-63 to consider costs associated with leasing or buying certain lighting equipment.

C. Case Studies

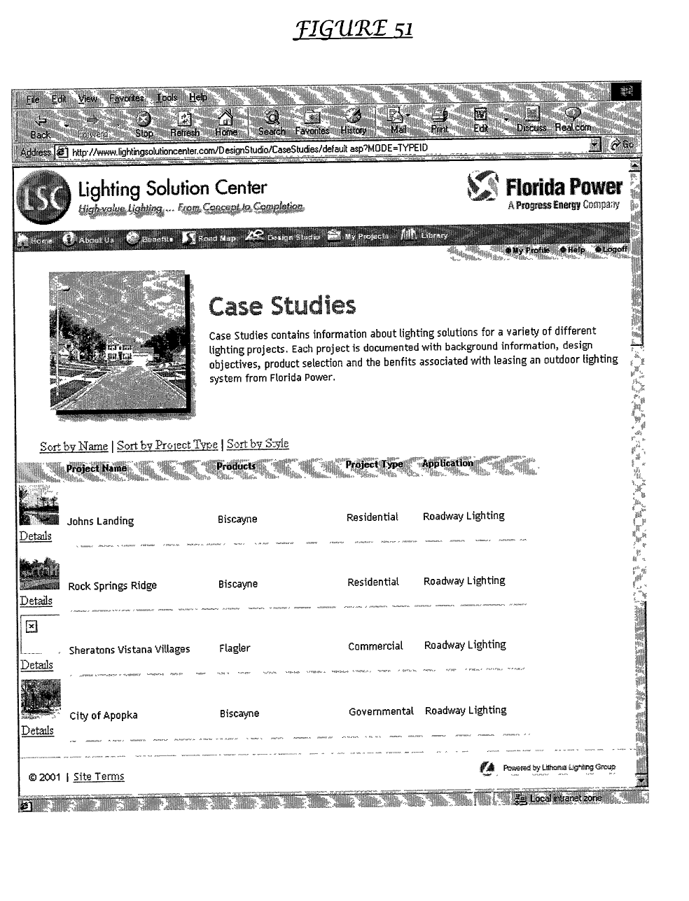

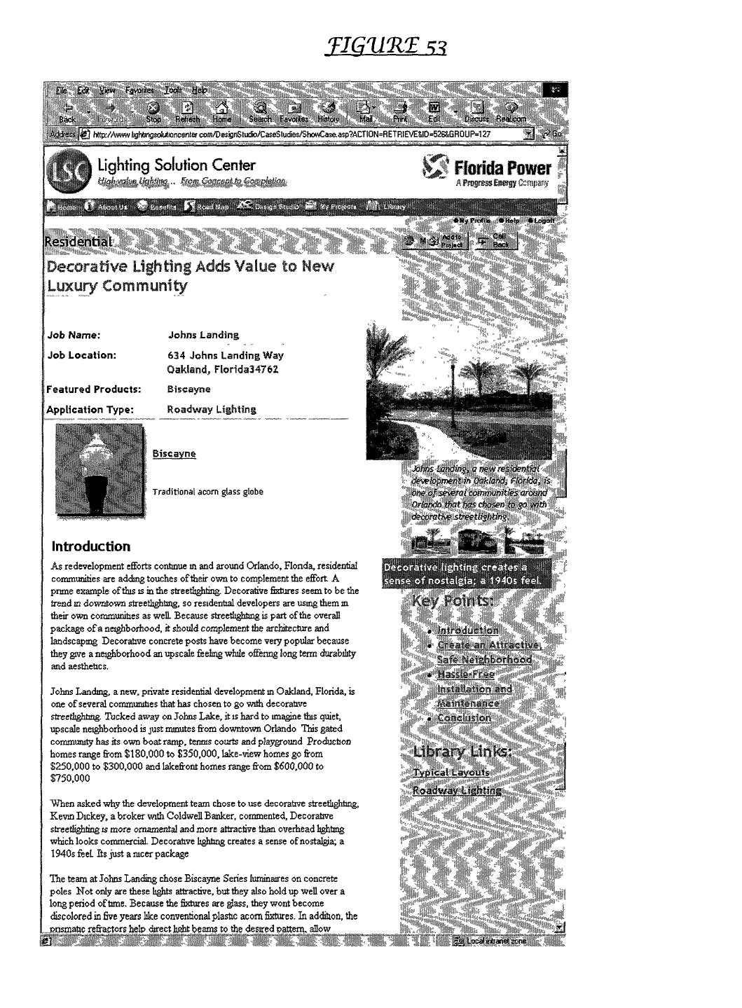

Users may view previously-completed or ongoing lighting projects in which the utility has participated, as shown in FIGS. 51-55. In one exemplary embodiment, Case Studies, as shown in FIGS. 51 and 53, provide users with information about lighting solutions for a variety of different real world lighting projects that are either already completed or in progress. Each project is documented with background information, design objectives, and benefits associated with leasing the lighting system. As shown in FIG. 51, users may sort case studies by name, project type, or style. Four roadway lighting case studies are shown in FIG. 51, and users may obtain details about each project by clicking on the link provided next to each project name. As an example, the John's Landing case study is shown in FIG. 53. Job location, featured products, application type, and other detailed information is provided about the project, including why the featured products were chosen and advantages of the featured products.

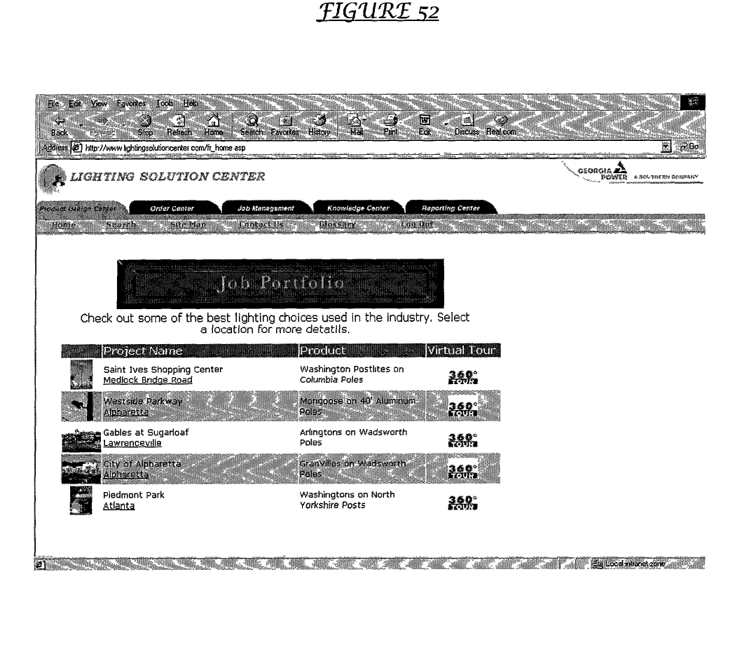

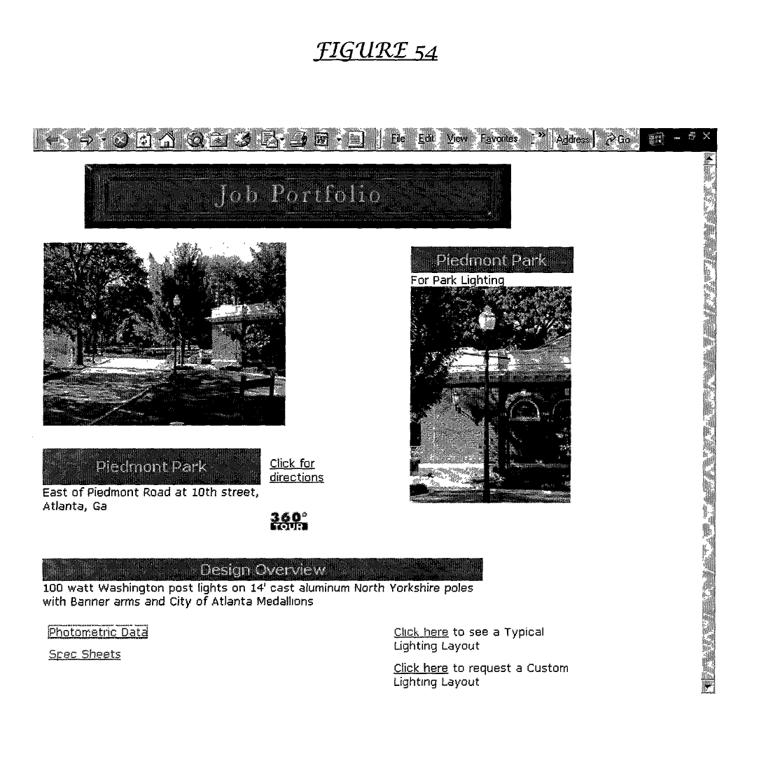

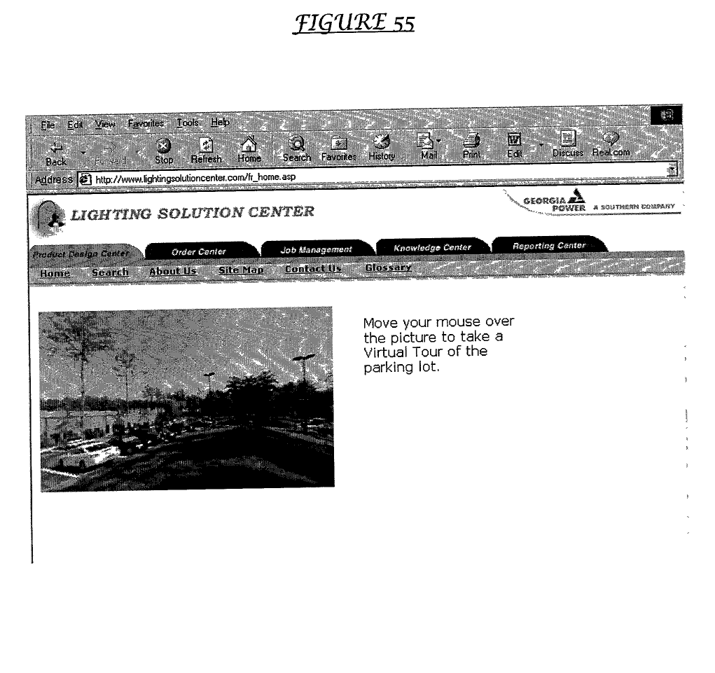

An alternate embodiment is shown in FIGS. 52, 54, and 55. Within the Job Portfolio, users can view lighting installation projects in the geographic area that utilize the products available from the utility. The portfolio includes information about the products installed and provides links to get driving directions for users to view the installation. Users can view these sample jobs by clicking on the link provided for each one. FIG. 54 shows a sample job done in Piedmont Park in Atlanta, Ga. Another feature is the 3600 Virtual Tour, as shown in FIG. 55. By entering the Virtual Tour, users can view three-dimensional images of actual lighting projects. Users are presented with several lighting scenarios such as retail parking area lighting, commercial street lighting, park and bike path lighting, and sports complex lighting. Once an application is selected, a three-dimensional image through which the user can move using a computer mouse, or other means, is loaded. Clicking on objects within the image will display specific information about the selected object, including lease rates, technical information, or ordering capabilities.

D. Calculators, including Lease/Buy Calculator

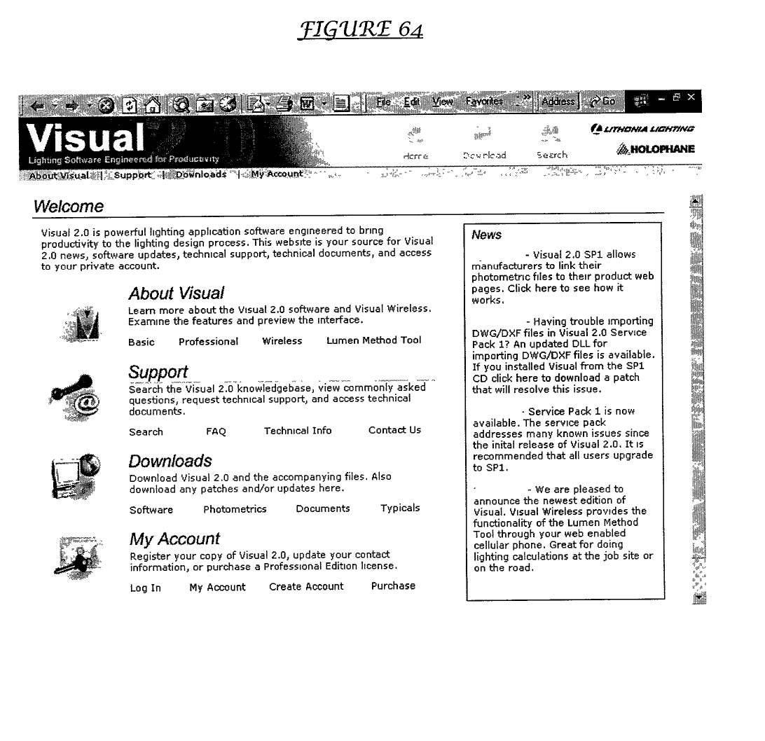

Another feature according to a system of the invention is the Calculators, as shown in FIG. 56. Although additional calculators may be provided to users, the exemplary embodiment provides two calculators: (1) a Visual Calculator and (2) a Lease/Buy Calculator. Visual is a lighting application software engineered to bring productivity to the lighting design process and is the subject of U.S. patent application Ser. No. 09/514,401 entitled “Interactive Computer-Aided Lighting Design Process and Apparatus,” filed Feb. 28, 2000, which is incorporated herein by reference in its entirety. Users may access a page that provides tutorials, account registration, and support as well as allowing downloading of the software, as shown in FIG. 64. If users choose to download Visual, the software guides them through steps required to design an outdoor lighting system. Users enter criteria about the area of the project and select a lighting system. Visual then provides information about how many luminaires to use, the appropriate spacing between fixtures, and the corresponding illuminance levels.

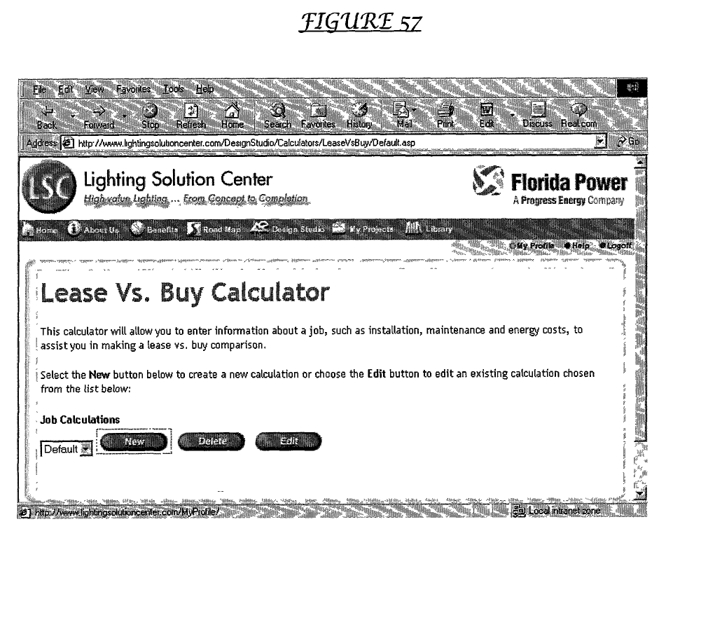

An exemplary Lease/Buy Calculator according to a system of the invention is shown in FIGS. 57-63. The calculator assists users in making a lease versus buy comparison based on information entered about a project, such as installation, energy, and maintenance costs. The calculator provides default values for much of this information, and users may change the information if they wish to provide a different or more exact value. Users select the “New” button to create a new calculation or choose the “Edit” button to edit an existing calculation chosen from the drop-down box, as shown in FIG. 57.

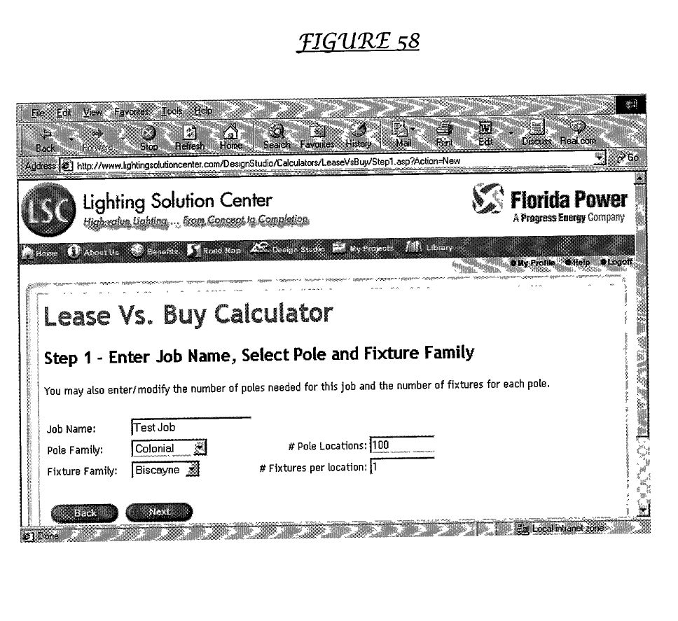

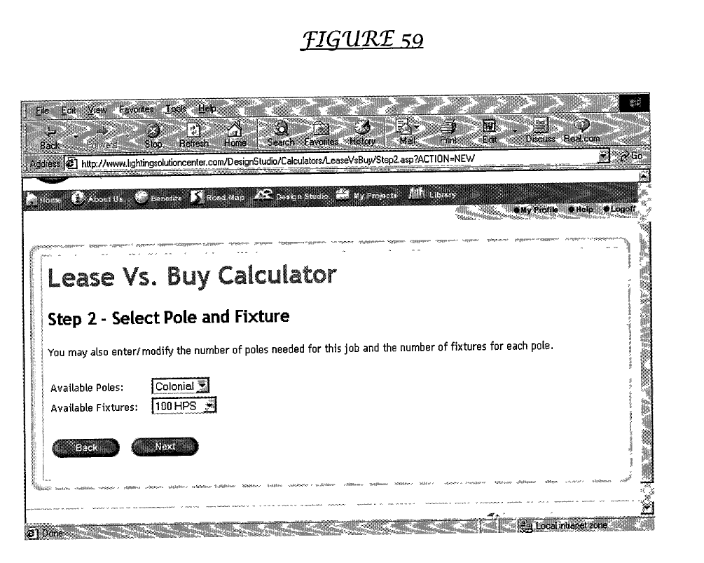

As an example, a new calculation is selected and the user proceeds to step 1, as shown in FIG. 58. Information required in step 1 includes job name, pole family, fixture family, number of pole locations, and number of fixtures per location. Drop-down boxes with numerous options allow users to choose from the available pole and fixture families. As shown in FIG. 59, users select a pole and a fixture within the families chosen in the previous step in the drop-down boxes provided. There may be one or more available fixtures or poles within each family.

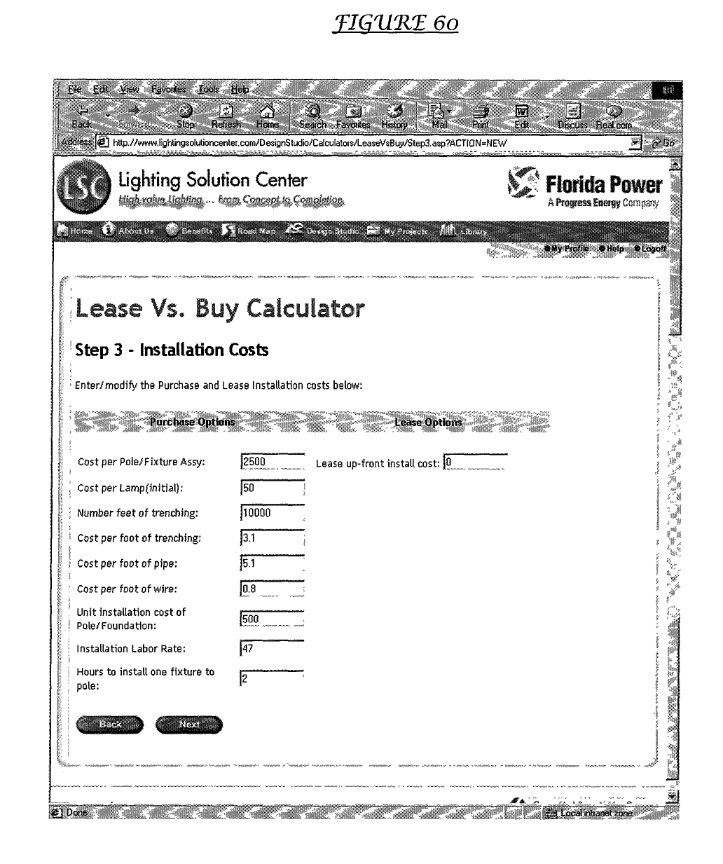

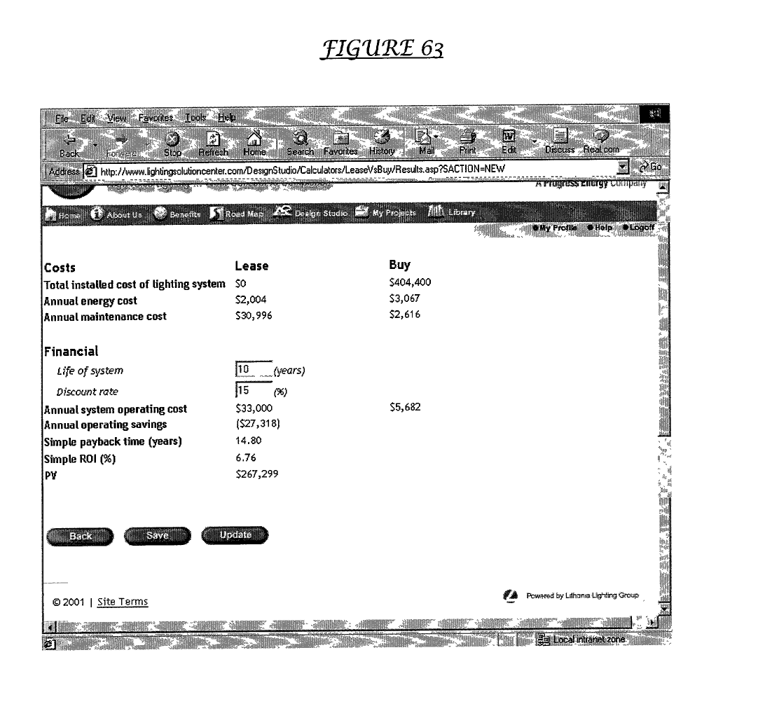

Steps 3-5 of the lease/buy calculation are shown in FIGS. 60-62. In these steps, users provide information regarding installation, energy, and maintenance costs. The calculator provides default values for each of these items. Users may modify the default values, which is particularly helpful when users have more accurate estimates than the default values. FIG. 63 shows the results of the example calculation. The results page allows users to compare the costs of owning and maintaining their own system or leasing the material from the utility, demonstrating the benefits of leased lighting programs available from the utility. Alternate embodiments may compare the costs associated with different lighting components or systems, such as, for example, indoor residential or restaurant lighting, or request different, additional, or less information from users.

V. My Projects

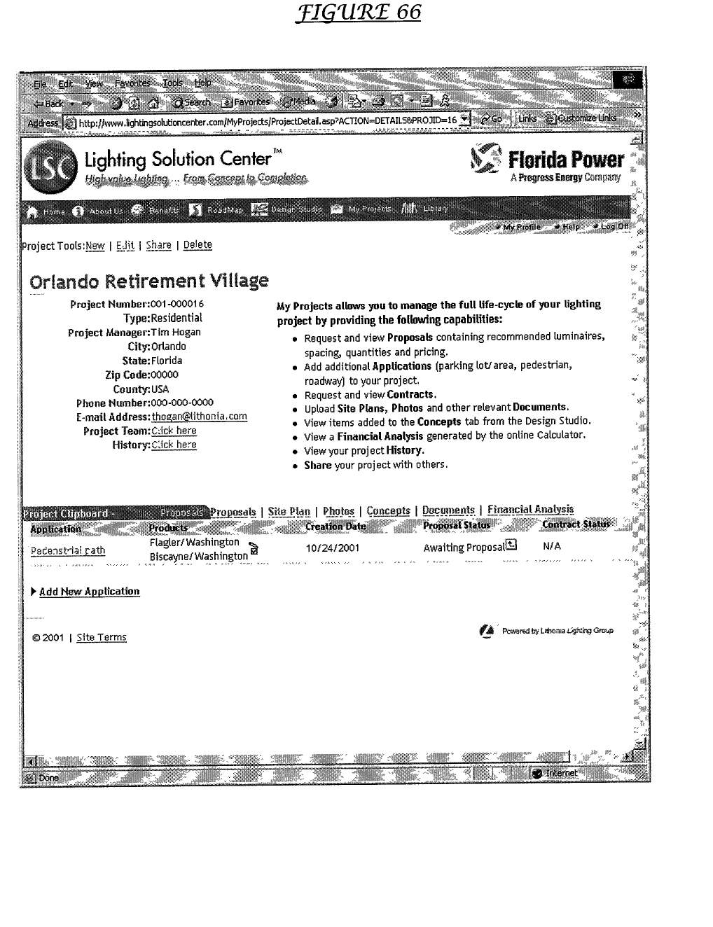

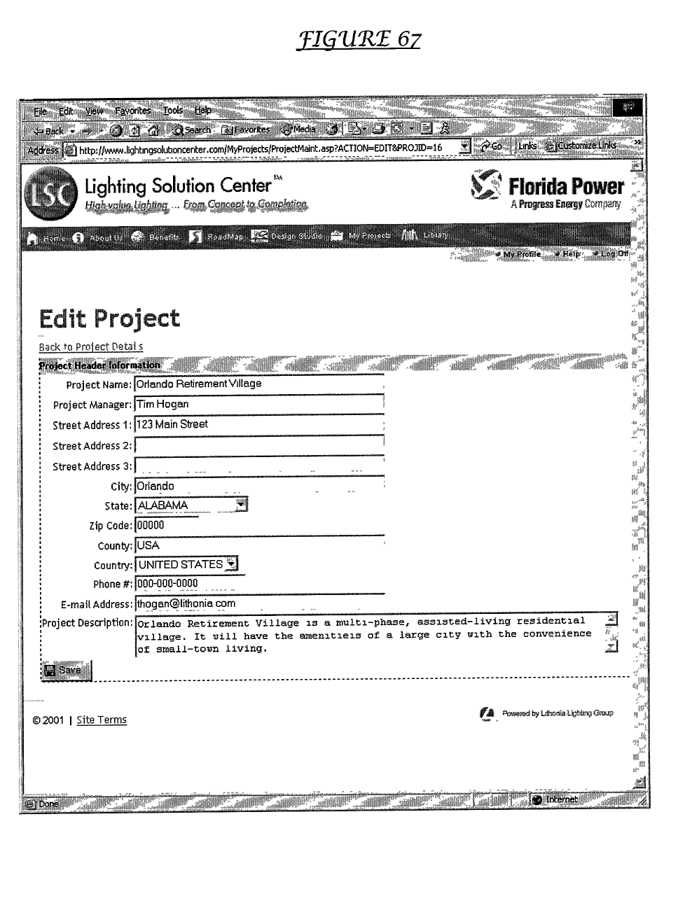

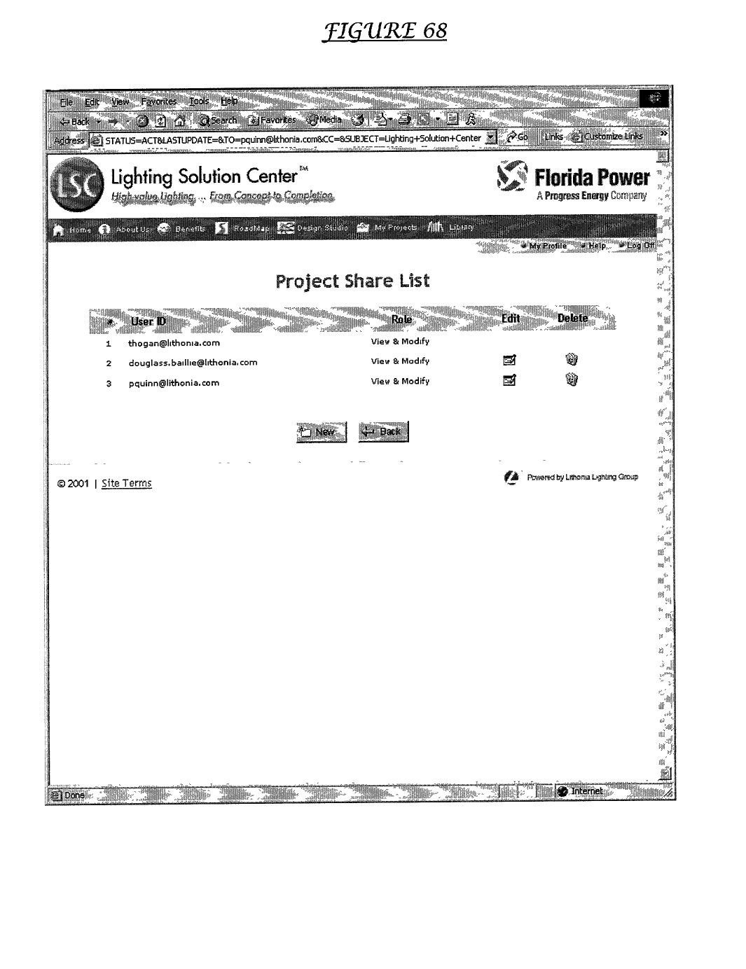

According to a system of the invention, a My Projects or Job Management functionality, as shown in FIGS. 65-76, allows users to manage the full life-cycle of their lighting projects. All current and previously created projects of the user are listed. As shown in FIG. 65 (and an alternate embodiment in FIG. 69), users can filter projects by any of the categories and sort projects by the headings. As an example, if a user selects the Orlando Retirement Village project, the user would see the screen shown in FIG. 66. This screen provides users with detailed information about the project, as well as links to other functionalities. Users may do any of the following from this screen: request and view proposals containing recommended luminaires, spacing, quantities, and pricing; add additional applications to a project; request and view contracts; upload site plans, photos, and other relevant documents; view financial analysis generated by available calculators; view project history; and share their projects with others. Users can edit projects, as shown in FIG. 67, and share the project with others, as shown in FIG. 68.

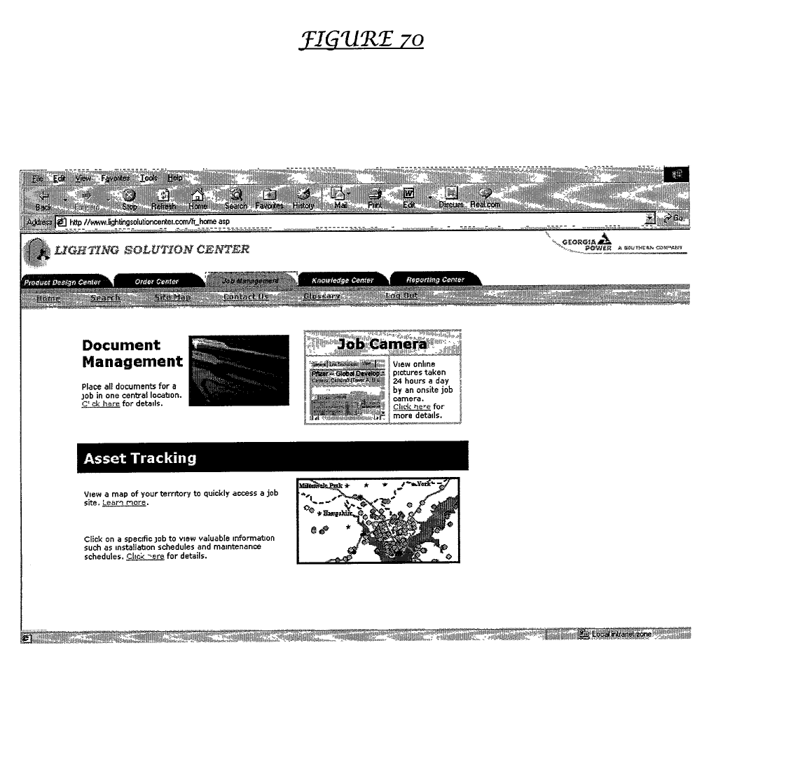

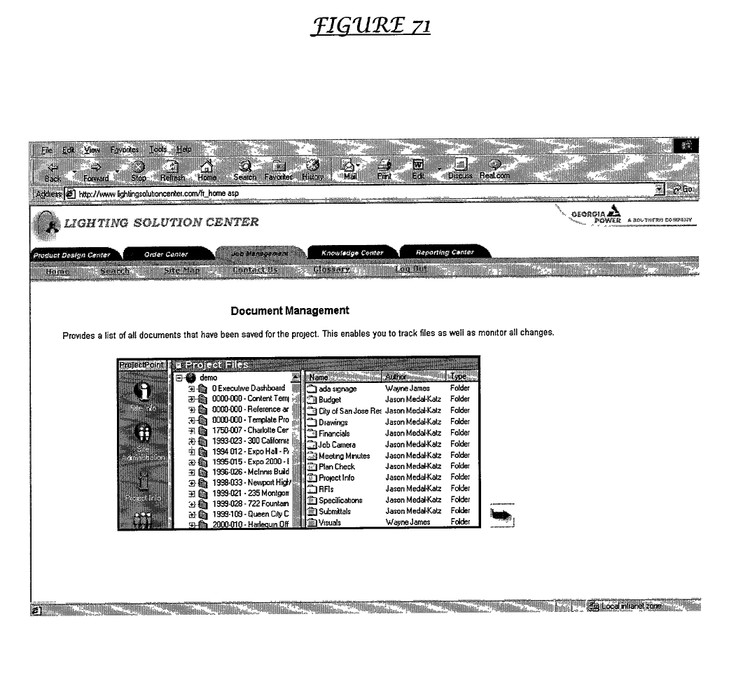

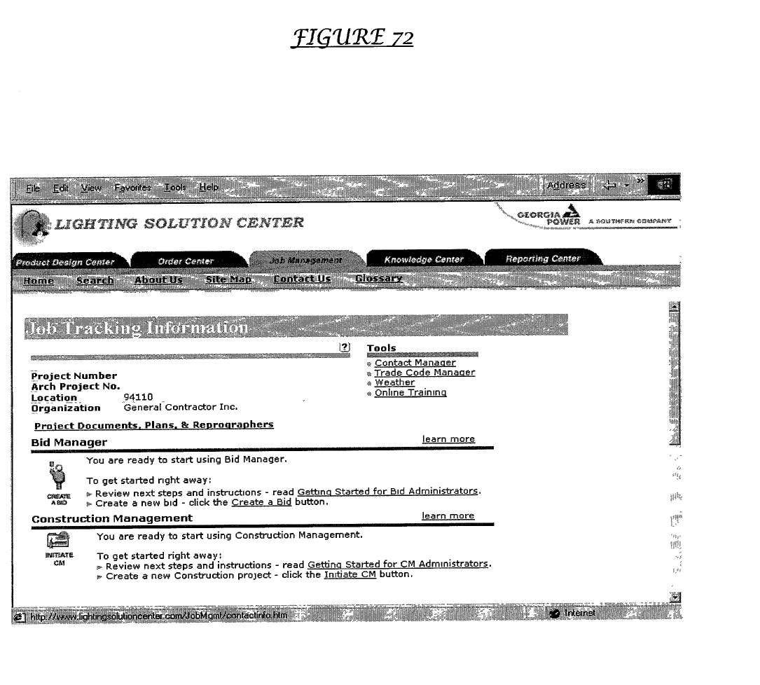

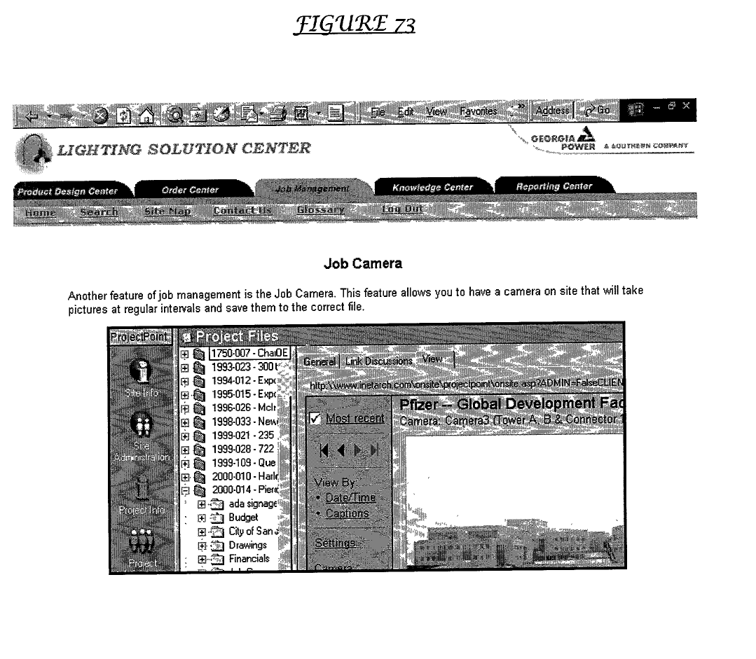

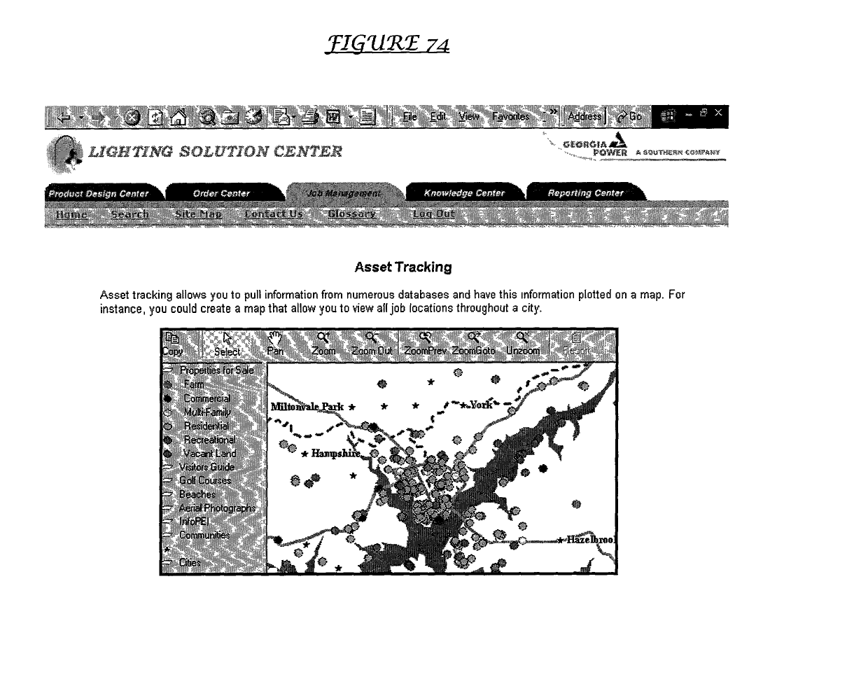

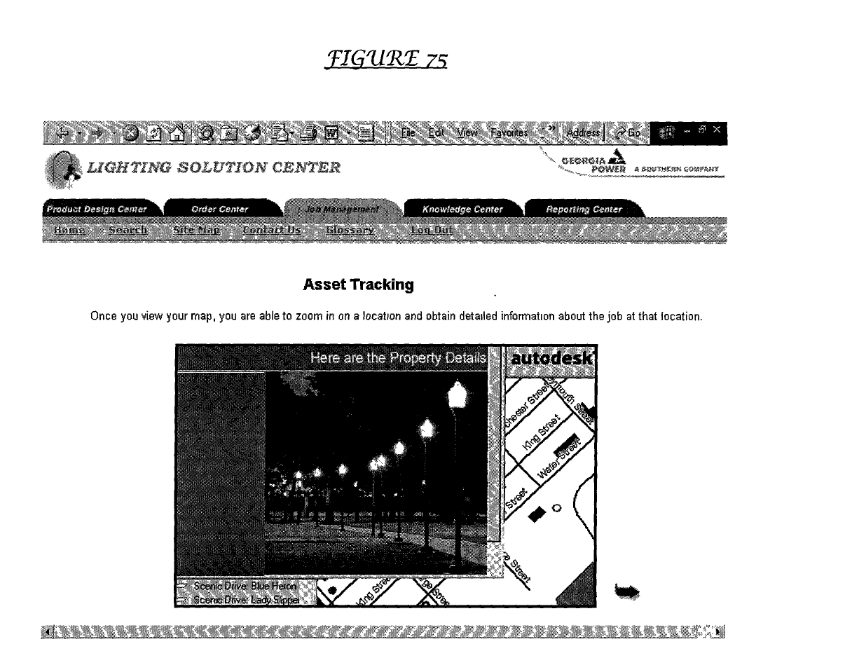

A main page for an embodiment of a job management center according to a system of the invention is shown in FIG. 70. This area is dedicated to helping utilities more efficiently manage the estimation, procurement, installation, and maintenance of lighting projects. A document management feature, shown in FIG. 71, allows users to view all documents that have been saved for a lighting project and to monitor changes to those documents. A job tracking feature, shown in FIG. 72, allows shipment schedules and crew availability to define installation schedules. As shown in FIG. 73, the job tracking feature provides a camera on a job site that takes pictures at regular intervals and stores those pictures to an appropriate file. An asset tracking tool is shown in FIGS. 74 and 75. The asset tracking tool identifies schedule conflicts and suggests alternative solutions, which helps insure that bids are accurate, construction scheduling is optimized, and crews are not waiting for material.

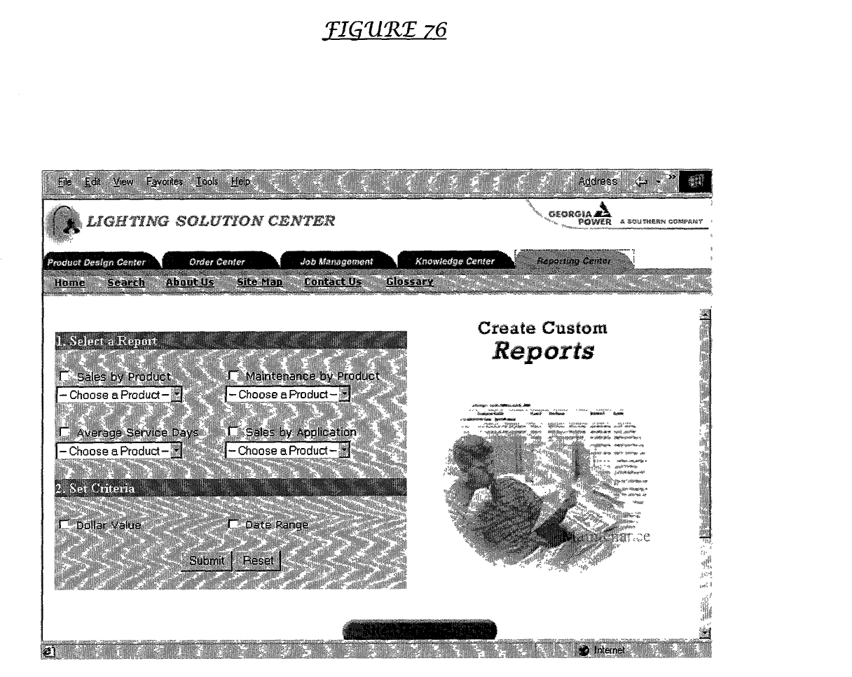

A reporting center, as shown in FIG. 76, allows utility personnel to track performance of the lighting program through utilization of a database generated from purchases, installation, and maintenance history. Typical reports may include sales by product, average days to perform service, sales by application, average days to install material, average material lead times, and average inventory turns. A job management center may also be utilized for crew communication and to dispatch personnel via electronic interfaces. PDA and web-based cellular technology can be incorporated to direct crews to the next assignment on a real-time basis. The interface can also notify storerooms of coming requirements to have material ready for crew pickup.

Additionally, a job or project management center may include web-based training programs to train personnel on proper installation and maintenance of all lighting systems. Utility crews receive recognition as being lighting-certified once training programs are completed and passed. Installation and maintenance manuals are available to be reviewed or printed by construction crews. In addition, remote troubleshooting is available through PDAs and web-ready cellular phones. Utility crews are able to follow a simple set of instructions for diagnosing equipment problems in the field. Once a problem is identified, the maintenance personnel can check inventory and order replacement parts immediately from the field through PDA and cell phone technology. By entering a date code, the field personnel can determine if a product is under warranty and initiate a claim from the field for replacement parts.

VI. Benefits

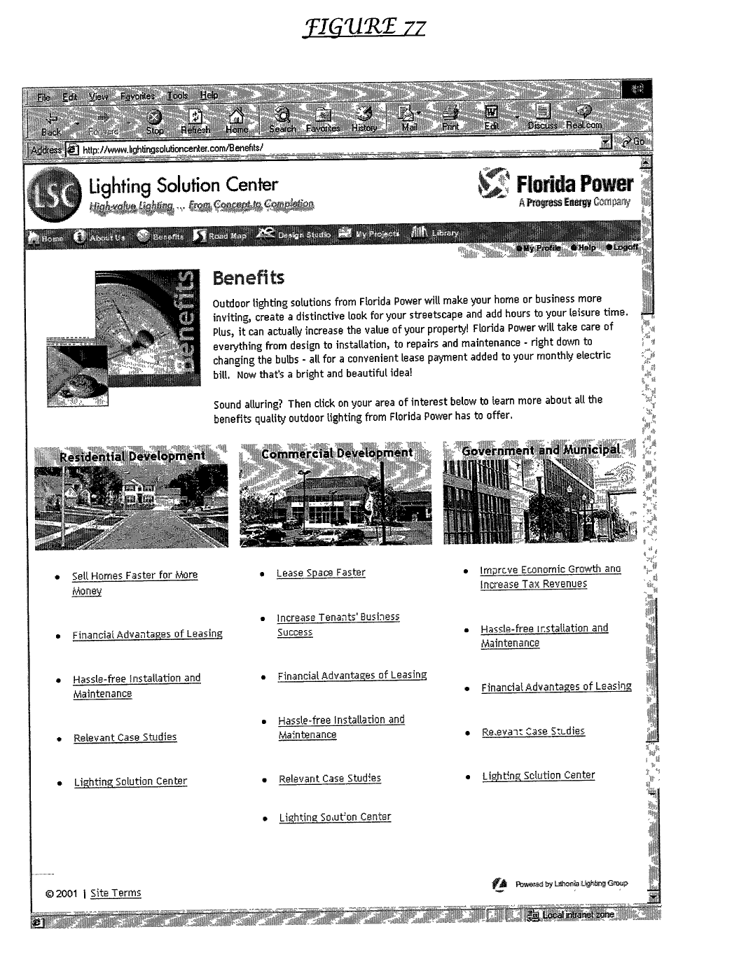

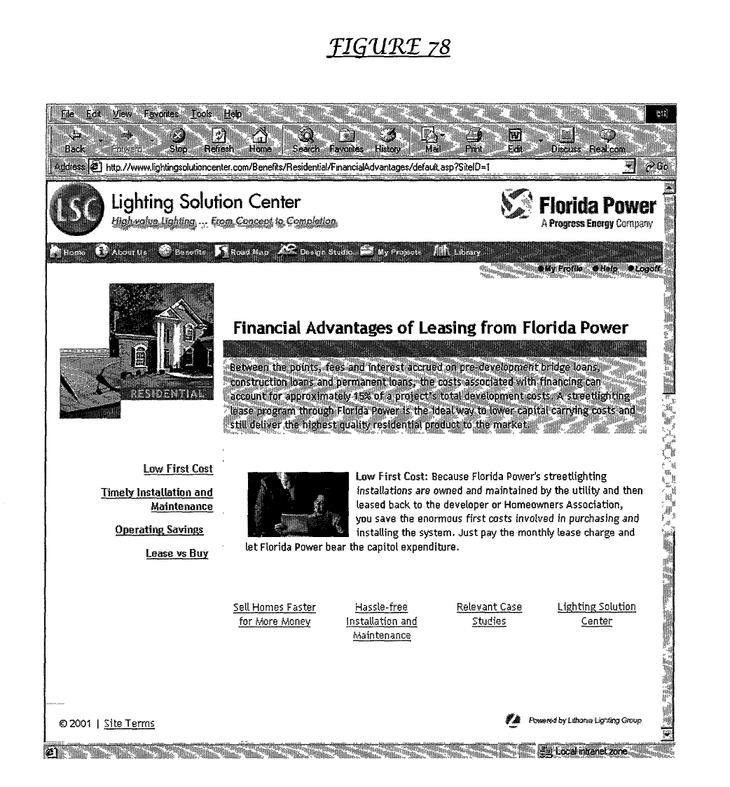

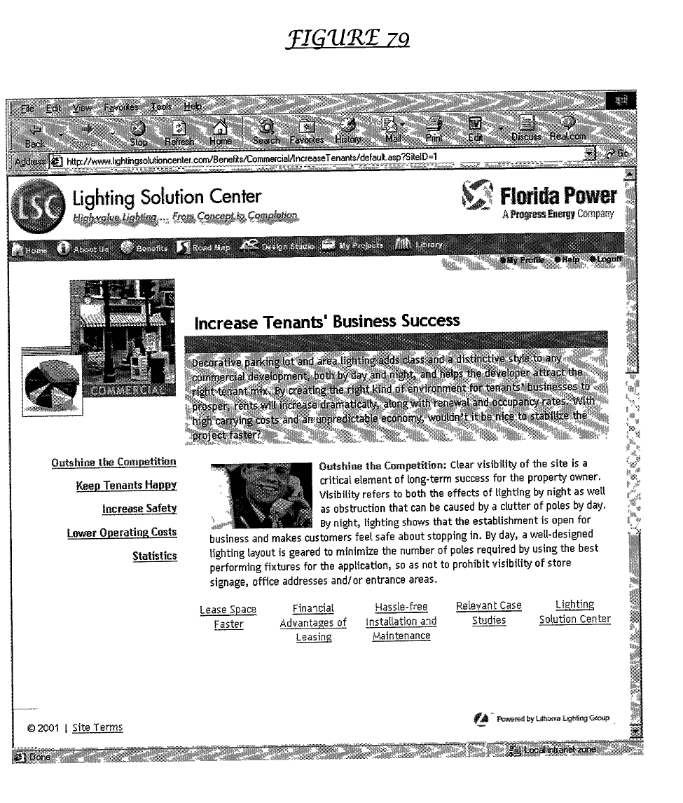

FIG. 77 shows an exemplary Benefits feature according to a system of the present invention. This feature allows users to click on an area of interest to learn more about the benefits of quality lighting. As shown in FIG. 77, users may view information related to residential and commercial developments, as well as government and municipal projects. Some examples of the types of information users may access are shown in FIGS. 78 and 79 and include financial advantages of leasing, relevant case studies (as discussed in detail above with regard to FIGS. 51-55), and hassle-free installation and maintenance.

FIG. 78 discusses the financial advantages of leasing a lighting system for a residential development. Links to further information on the financial advantages of leasing are provided on the left side of the screen, while the links at the bottom of the screen connect to additional information on residential developments that may also be accessed from the screen shown in FIG. 77. FIG. 79 provides information regarding how a commercial lighting system increases tenants' business success. Links to further information on increasing tenants' business success are provided on the left side of the screen, while the links at the bottom of the screen connect to additional information on commercial developments that may also be accessed from the screen shown in FIG. 77. Alternate embodiments may allow users to view various information on numerous additional types of lighting projects such as, for example, restaurant, warehouse, indoor residential, professional or office building, and sports arena lighting.

VII. Lighting Library

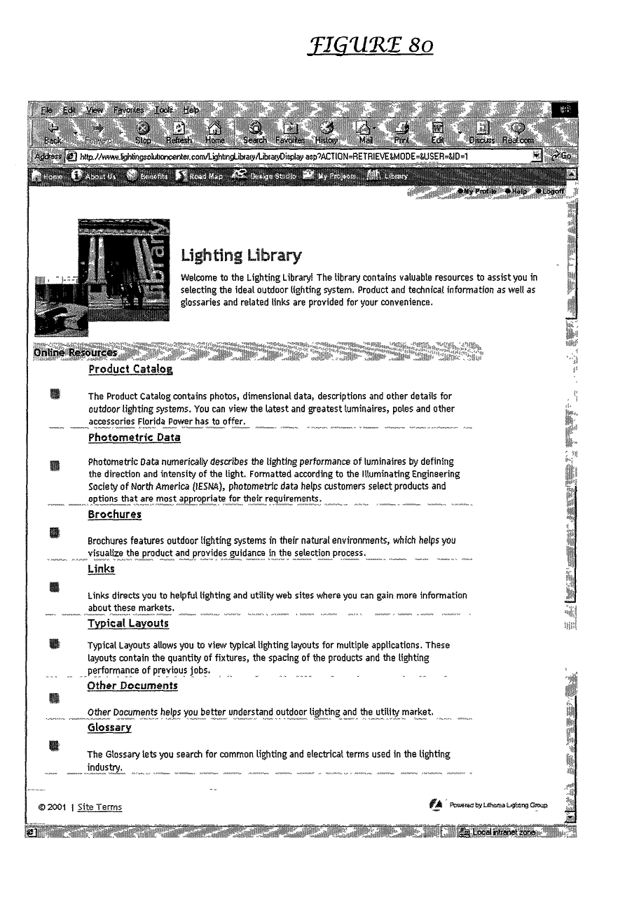

Another feature according to a system of the invention is a Lighting Library, which is shown in FIGS. 80-93. The Lighting Library contains valuable resources to assist users in selecting the ideal lighting systems and is a central repository of information on lighting technology and the utility's lighting program. Product and technical information as well as glossaries and related links are provided. As shown in FIG. 80, the Lighting Library contains a link to the Product Catalog, shown in FIGS. 34-42 and discussed in detail above, as well as other sources of information.

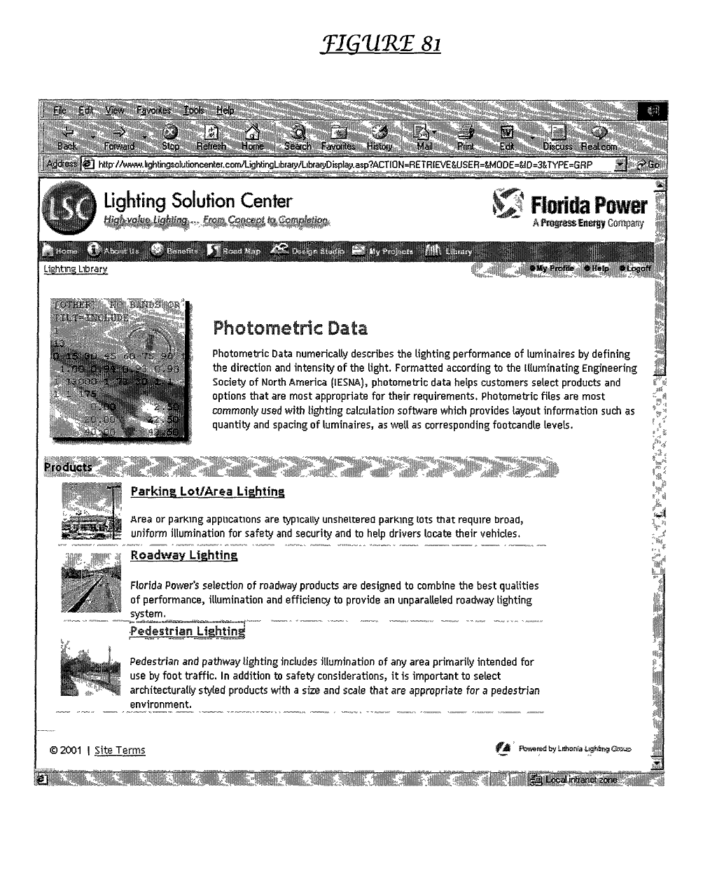

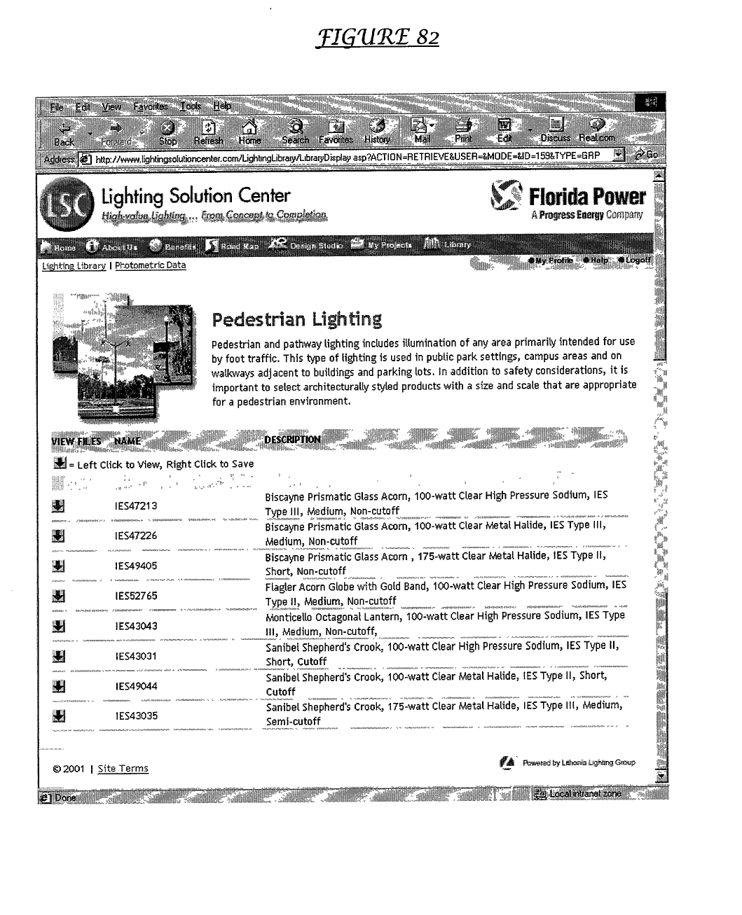

General information is provided about photometric data, as shown in FIG. 81. Photometric data numerically describes the lighting performance of luminaires by defining the directions and intensity of the light. The data helps customers select products and options that are most appropriate for their requirements. In the example shown in FIG. 81, users may select among three categories from which to view photometric data, and FIG. 82 shows photometric files available for light fixtures used in pedestrian lighting. Users may either view or save a photometric file, as indicated in FIG. 82. Photometric files (not shown) are commonly used with lighting calculation software which provides layout information such as quantity and spacing of luminaires, as well as corresponding foot candle levels.

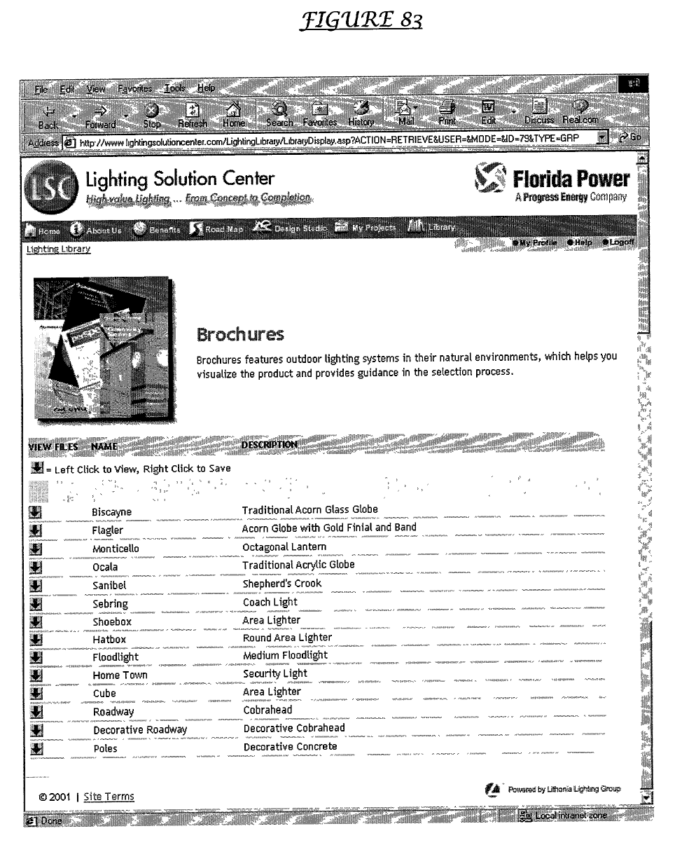

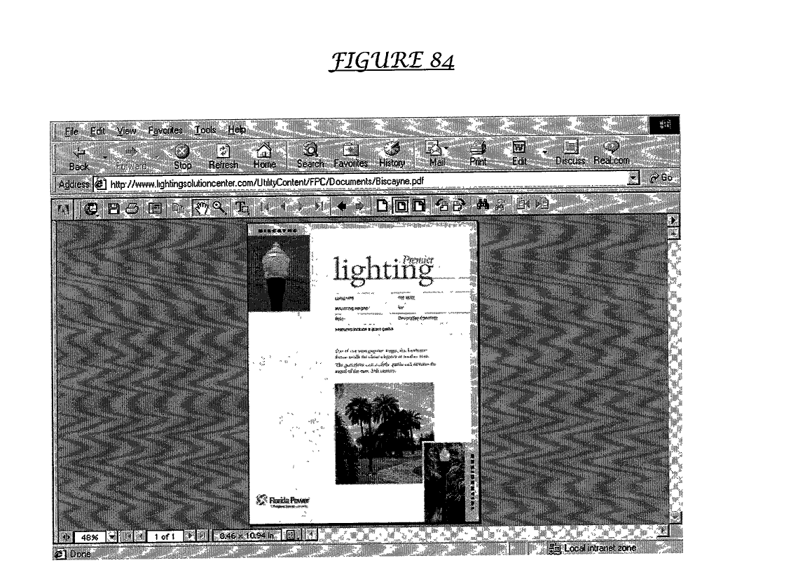

FIGS. 83 and 84 illustrate product brochures available through the Lighting Library. Users may access brochures featuring lighting components or lighting systems in their natural environments, aiding users in visualizing the products and providing guidance in the selection process. As shown in FIG. 83, brochures are available for numerous lighting products. As an example, FIG. 84 shows a brochure, in PDF format, for the Biscayne lighting fixture. The brochure provides basic information in addition to multiple images of the product.

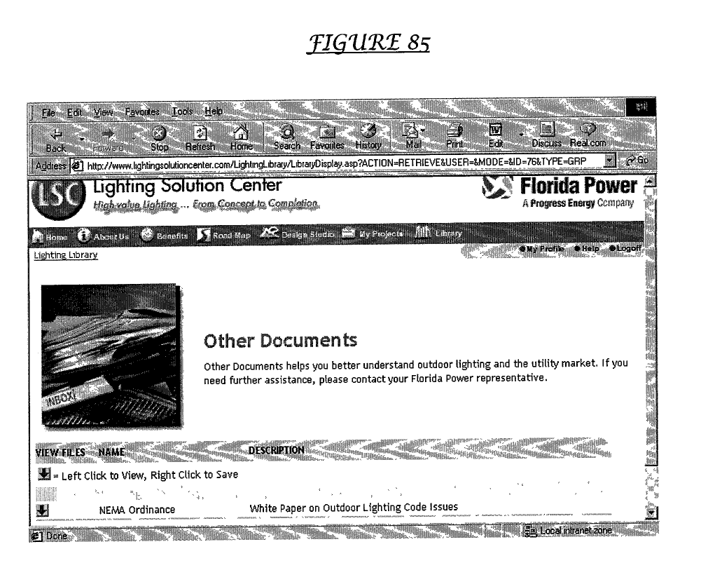

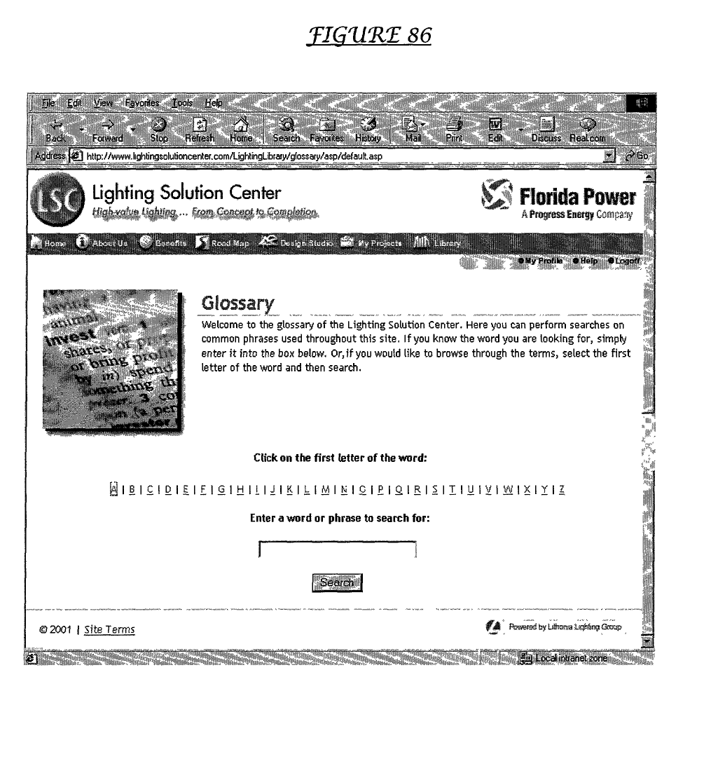

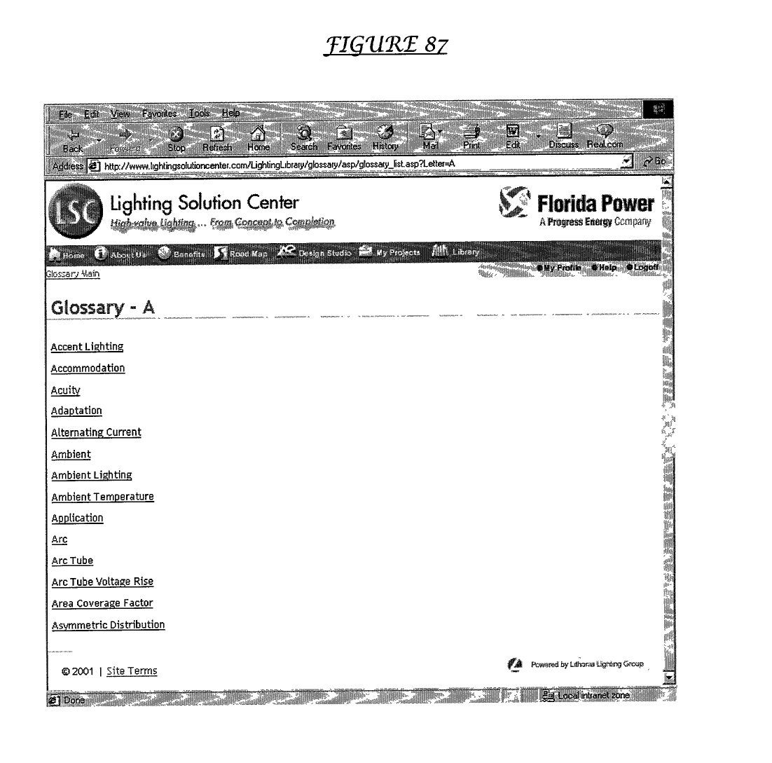

The Lighting Library also provides links to a Links page and Typical Layouts. The Links page contains links to helpful lighting and utility websites where users can obtain more information. The link to Typical Layouts allows users to see typical lighting layouts for multiple applications similar to the case studies or job portfolios, as shown in FIGS. 51-55 and discussed in detail above. The Lighting Library also provides users with access to Other Documents, as shown in FIG. 85. In the exemplary screen shot shown in FIG. 85, users would have access to a file entitled “NEMA Ordinance,” which is a white paper on outdoor lighting code issues. Other useful papers, guides, and informational documents may be added to this section as the utility or site administrator sees fit. The Lighting Library also features a Glossary, shown in FIGS. 86 and 87, that allows users to search for common lighting and electrical terms used in the lighting industry.

The foregoing description of the exemplary embodiments of the invention has been presented only for the purposes of illustration and description and is not intended to be exhaustive or to limit the invention to the precise forms disclosed. Many modifications and variations are possible in light of the above teaching.

The embodiments were chosen and described in order to explain the principles of the invention and their practical application so as to enable others skilled in the art to utilize the invention and various embodiments and with various modifications as are suited to the particular use contemplated. Alternative embodiments will become apparent to those skilled in the art to which the present invention pertains without departing from its spirit and scope. Accordingly, the scope of the present invention is defined by the appended claims rather than the foregoing description and the exemplary embodiments described therein.

What is claimed is:

1. A system for assisting a user in developing a lighting system for a lighting project, comprising:
a tool being operative to provide assistance to the user in selecting the lighting system for the lighting project, the tool prompting the user for:
selecting a type of the lighting project,
providing characteristics describing the lighting project,
providing a set of criteria the user desires the lighting system to satisfy, and
selecting a component for the lighting system, wherein the tool presents the user with at least one component for the lighting system in response to the selection of the type, the characteristics, and the set of criteria; and
a design center including a plurality of images of lighting components and a plurality of images of background scenes, wherein the user may view any of the plurality of images of lighting components within any of the plurality of images of background scenes.

2. The system of claim 1, wherein the at least one component for the lighting system comprises a plurality of components for the lighting system.

3. The system of claim 1, wherein the tool is for providing a first set of photometric data for a first component and a second set of photometric data for a second component, whereby the user may compare the first and second sets of photometric data.

4. The system of claim 2, wherein the tool is for providing a first set of financial data for a first component and a second set of financial data for a second component, whereby the user may compare the first and second sets of financial data.

5. The system of claim 2, wherein the tool is for visually comparing a first component and a second component.

6. The system of claim 1, wherein the tool is for receiving a copy of a site plan for the lighting project.

7. The system of claim 1, wherein the tool is for prompting the user to submit a proposal request for the lighting system and for receiving the proposal request from the user.

8. The system of claim 7, wherein the tool is for providing a proposal to the user.

9. The system of claim 8, wherein the tool is for posting the proposal for viewing over a computer network.

10. The system of claim 1, wherein the tool is for accepting an order from the user for the lighting system.

11. The system of claim 10, wherein the tool is for providing tracking information to the user to allow the user to track the order for the lighting system.

12. The system of claim 1, wherein the tool is for providing status information to the user to allow the user to monitor installation of the lighting system.

13. The system of claim 1, wherein the design center is for receiving an image of a background scene uploaded by the user.

14. The system of claim 1, wherein the design center includes images of outdoor lighting equipment.

15. The system of claim 1, wherein the design center includes images of indoor lighting equipment.

16. The system of claim 1, wherein the design center is operative for viewing a selected lighting component with a selected background image scene and for interchanging the selected lighting component with a second lighting component so that the second lighting component may be viewed with the selected background scene.

17. The system of claim 1, wherein the design center is operative for viewing a selected lighting component with a selected background image scene and for interchanging the selected background scene with a second background scene so that the selected lighting component may be viewed with the second background scene.

18. A method for assisting a user in developing a lighting system for a lighting project, comprising:
obtaining from the user an identification of a type of the lighting project;
obtaining from the user characteristics of the lighting project;
obtaining from the user a set of criteria that the lighting system should satisfy;
in response to the identification of the type, the characteristics, and the set of criteria, presenting at least one component for the lighting system; and
prompting submission of a request for a proposal for the lighting system.

19. The method of claim 18, wherein the at least one component for the lighting system comprises a plurality of components for the lighting system.

20. The method of claim 19, further comprising providing a first set of photometric data for a first component and a second set of photometric data for a second component, whereby the user may compare the first and second sets of photometric data.

21. The method of claim 19, further comprising providing a first set of financial data for a first component and a second set of financial data for a second component, whereby the user may compare the first and second sets of financial data.

22. The method of claim 19, further comprising visually comparing a first component and a second component.

23. The method of claim 18, further comprising prompting submission of a copy of a site plan for the lighting project.

24. The method of claim 18, further comprising posting the proposal for viewing over a computer network.

25. The method of claim 18, further comprising providing notification that the proposal is complete.

26. A system for assisting a user in developing a lighting system for a lighting project, comprising:
a plurality of images of background scenes, wherein any of the plurality of images of background scenes may be selected for display; and
a plurality of images of lighting components, wherein any of the plurality of images of lighting components may be selected for display within any of the plurality of images of background scenes;
wherein a selected background scene image or a selected lighting component image may be interchanged to view various combinations of lighting components and background scenes.

27. The system of claim 26, wherein the selected lighting component image may be moved within the selected background scene image.

28. The system of claim 26, wherein the selected lighting component image may be resized within the selected background scene image.

29. The system of claim 26, further comprising a tool allowing for a background scene image to be uploaded into the plurality of images of background scenes.

30. The system of claim 26, wherein the plurality of images of lighting components comprises images of indoor lighting equipment.

31. The system of claim 26, wherein the plurality of images of lighting components comprises images of outdoor lighting equipment.
